(19) United States
(12) Patent Application Publication
(10) Pub. No.: US 2023/0385875 A1
(43) Pub. Date: Nov. 30, 2023

(54) SMART SHOPPING CART WITH ONBOARD COMPUTING SYSTEM GATHERING CONTEXTUAL DATA AND DISPLAYING INFORMATION RELATED TO AN ITEM BASED THEREON

(71) Applicant: Maplebear Inc. (dba Instacart), San Francisco, CA (US)

(72) Inventor: Leho Nigul, Aurora (CA)

(21) Appl. No.: 17/824,696

(22) Filed: May 25, 2022

(51) Int. Cl. G06Q 30/02

(52) U.S. Cl. CPC G06Q 30/0255; G06Q 30/0261; G06Q 30/0242

(57) ABSTRACT

A shopping cart system detects the initiation of a shopping session within a physical retail store by a customer, in which the shopping cart system includes a shopping cart, a processor, a memory, and a set of sensors. Contextual information associated with the shopping cart received by the sensors during the shopping session is tracked, in which the contextual information describes one or more locations of the shopping cart within the store, a state of the shopping cart, and a set of items within the shopping cart. Responsive to identifying an opportunity to present content to the customer based on the contextual information, the system identifies a set of content items associated with one or more items within the store based on the contextual information. The system generates a user interface including the set of content items and sends the user interface to a display area associated with the customer.

### BACKGROUND

This disclosure relates generally to displaying information related to an item in a physical store, and more specifically to displaying information related to an item in a physical retail store based on contextual information associated with a shopping cart system.

Physical retail stores typically offer a wide variety of items to their customers since different customers may be interested in different items for reasons that are specific to each customer (e.g., personal preferences, quality, price, materials, sustainability, etc.). For example, a customer of a physical grocery store who is on a budget and is a vegetarian is likely to be interested in store-brand, meat-free products, while another customer who enjoys barbequing and often splurges on food is less likely to be interested in the same products. To encourage their customers to purchase new items with which they may be unfamiliar and to purchase more items with which they are already familiar, physical retail stores may offer incentives for customers to purchase different items (e.g., by periodically offering promotions or discounts on the items). For example, each week, a physical retail store may have sales or offer discounts for different items and may change sample or promotional displays throughout the store that feature different items.

But despite the incentives provided by physical retail stores, customers who would otherwise purchase certain items from the stores might still not do so for various reasons. In some instances, customers may refrain from purchasing items due to a lack of information about the items. For example, if a physical grocery store carries an exotic fruit, customers who would enjoy the fruit, but do not know anything about it other than basic information provided by the grocery store, such as its name and price, are not likely to purchase the fruit without additional information about it (e.g., what it tastes like, how to prepare it, nutritional information, etc.). Furthermore, in the above example, even if the majority of customers who come across the fruit have client devices (e.g., smartphones) available to research the fruit, the customers may find it too burdensome to do so, especially if they did not originally intend to purchase the fruit. Customers also may not purchase certain items that they otherwise would because they are unaware that the items exist. For example, if a customer who enjoys cookies and is on a diet is unaware that their favorite cookie is now available in a sugar-free version, they cannot purchase the new version of the cookies as long as they do not know that they exist. Additionally, customers may not purchase certain items because they forget to do so during their shopping sessions. For example, without a reminder, a customer who purchases pasta may simply forget to purchase pasta sauce to go with the pasta.

### SUMMARY

Physical retail stores typically offer a wide variety of items to their customers since different customers may be interested in different items for reasons that are specific to each customer. To encourage their customers to purchase new items with which they may be unfamiliar and to purchase more items with which they are already familiar, physical retail stores may offer incentives (e.g., promotions or discounts) for customers to purchase different items. However, despite these incentives, customers who would otherwise purchase certain items from physical retail stores may fail to do so for various reasons (e.g., if information about the items is not easily available, if they are unaware that the items exist, or if they simply forget to purchase the items).

In accordance with one or more aspects of the disclosure, to encourage customers to purchase new items with which they may be unfamiliar and to purchase more items with which they are already familiar, information related to an item in a physical retail store is displayed based on contextual information associated with a shopping cart system. More specifically, the shopping cart system detects the initiation of a shopping session within the physical retail store by a customer, in which the shopping cart system includes a shopping cart, a processor, a memory, and a set of sensors. The shopping cart system tracks contextual information associated with the shopping cart received by the sensors during the shopping session. The contextual information tracked by the shopping cart system describes one or more locations of the shopping cart within the physical retail store, a state of the shopping cart, and a set of items within the shopping cart, in which the state of the shopping cart indicates whether the shopping cart is moving or stationary. The shopping cart system identifies an opportunity to present content to the customer based in part on the contextual information. The shopping cart system then identifies a set of content items associated with one or more items within the physical retail store based on the contextual information, generates a user interface including the set of content items, and sends the user interface to a display area associated with the customer.

### BRIEF DESCRIPTION OF THE DRAWINGS

FIG. 1 is a block diagram of a system environment in which a shopping cart system and an online system, such as an online concierge system, operate, according to one or more embodiments.

FIG. 2 illustrates an environment of a shopping cart system and an online concierge system, according to one or more embodiments.

FIG. 3 is a diagram of a shopping cart system and an online concierge system, according to one or more embodiments.

FIG. 4 is a flowchart of a method for displaying information related to an item in a physical retail store based on contextual information associated with a shopping cart system, according to one or more embodiments.

FIG. 5 illustrates a planogram associated with a physical retail store, according to one or more embodiments.

FIG. 6 illustrates content items related to one or more items within a physical retail store, according to one or more embodiments.

The figures depict embodiments of the present disclosure for purposes of illustration only. Alternative embodiments of the structures and methods illustrated herein may be employed without departing from the principles, or benefits touted, of the disclosure described herein.

### DETAILED DESCRIPTION

### System Architecture

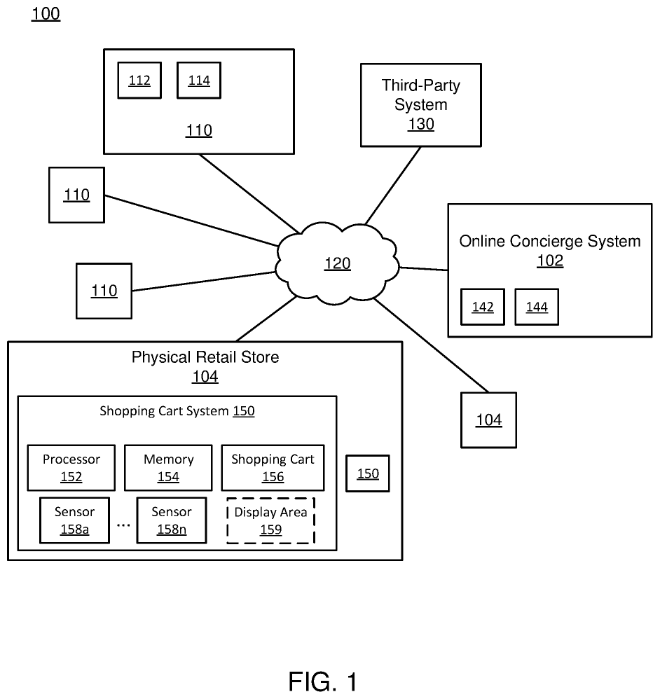

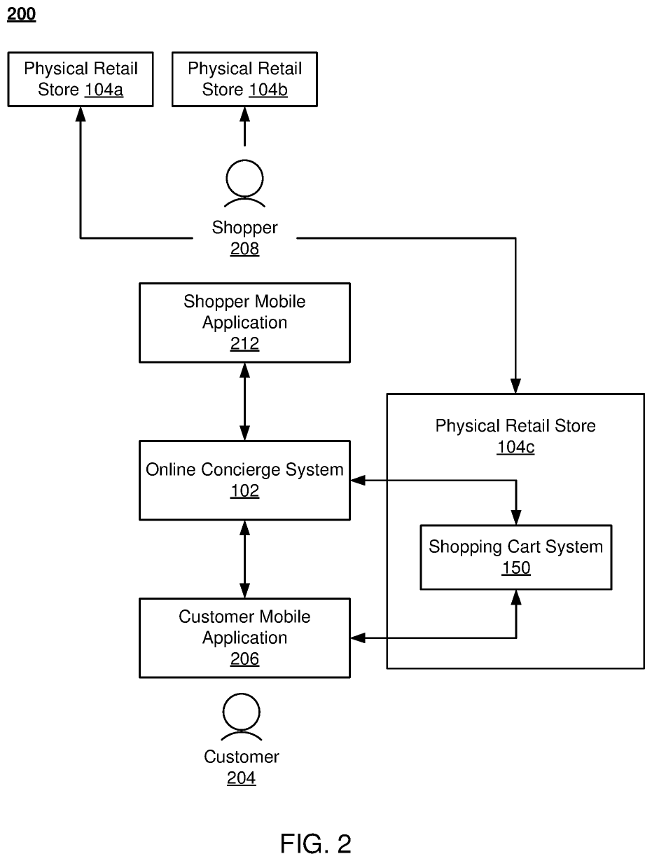

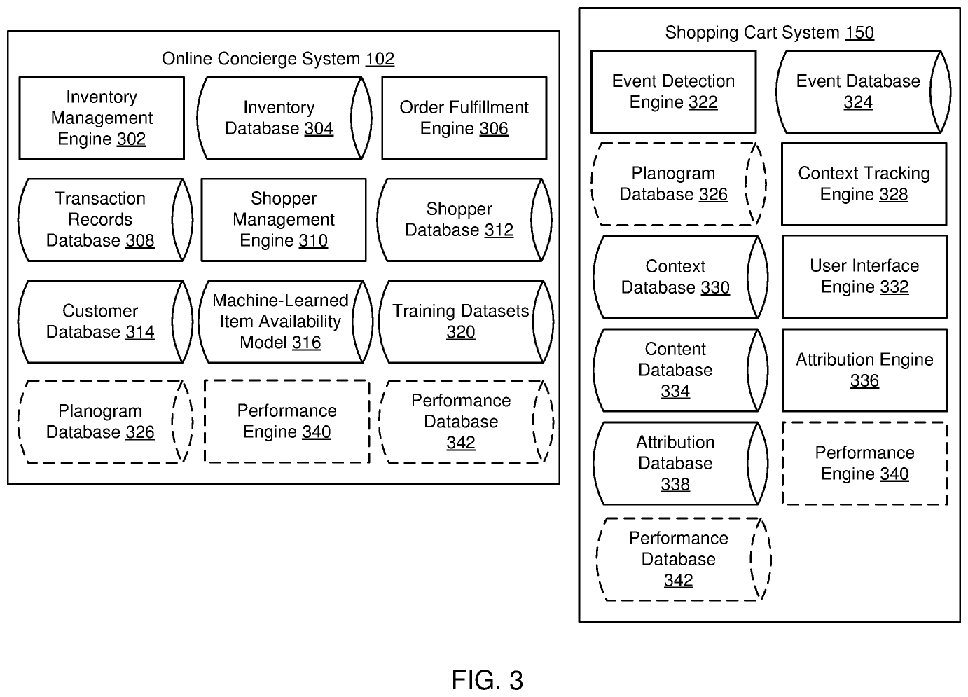

FIG. 1 is a block diagram of a system environment 100 in which a shopping cart system 150 and an online system, such as an online concierge system 102 as further described below in conjunction with FIGS. 2 and 3, operate. The system environment 100 shown in FIG. 1 comprises one or more client devices 110, a network 120, one or more third-party systems 130, one or more physical retail stores 104, and the online concierge system 102. In alternative configurations, different and/or additional components may be included in the system environment 100. Additionally, in other embodiments, the online concierge system 102 may be replaced by an online system configured to retrieve content for display to users and to transmit the content to one or more client devices 110 for display.

The client devices 110 are one or more computing devices capable of receiving user input as well as transmitting and/or receiving data via the network 120. In one embodiment, a client device 110 is a computer system, such as a desktop or a laptop computer. Alternatively, a client device 110 may be a device having computer functionality, such as a personal digital assistant (PDA), a mobile telephone, a smartphone, or another suitable device. A client device 110 is configured to communicate via the network 120. In one embodiment, a client device 110 executes an application allowing a user of the client device 110 to interact with the online concierge system 102. For example, the client device 110 executes a customer mobile application 206 or a shopper mobile application 212, as further described below in conjunction with FIG. 2, to enable interaction between the client device 110 and the online concierge system 102. As an additional example, a client device 110 executes a browser application to enable interaction between the client device 110 and the online concierge system 102 via the network 120. In another embodiment, a client device 110 interacts with the online concierge system 102 through an application programming interface (API) running on a native operating system of the client device 110, such as IOS® or ANDROID™.

A client device 110 includes one or more processors 112 configured to control operation of the client device 110 by performing various functions. In various embodiments, a client device 110 includes a memory 114 comprising a non-transitory storage medium on which instructions are encoded. The memory 114 may have instructions encoded thereon that, when executed by the processor 112, cause the processor 112 to perform functions to execute the customer mobile application 206 or the shopper mobile application 212 to provide the functions further described below in conjunction with FIG. 2.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third-party systems 130 may be coupled to the network 120 for communicating with the online concierge system 102, the client device(s) 110, or the physical retail store(s) 104. In one embodiment, a third-party system 130 is an application provider communicating information describing applications for execution by a client device 110 or communicating data to client devices 110 for use by an application executing on the client device 110. In other embodiments, a third-party system 130 provides content or other information for presentation via a client device 110. For example, a third-party system 130 stores one or more web pages and transmits the web pages to a client device 110 or to the online concierge system 102. A third-party system 130 may also communicate information to the online concierge system 102, such as advertisements, content, or information about an application provided by the third-party system 130.

The online concierge system 102 includes one or more processors 142 configured to control operation of the online concierge system 102 by performing various functions. In various embodiments, the online concierge system 102 includes a memory 144 comprising a non-transitory storage medium on which instructions are encoded. The memory 144 may have instructions encoded thereon corresponding to the modules further described below in conjunction with FIG. 3 that, when executed by the processor 142, cause the processor 142 to perform the functionality further described below in conjunction with FIG. 2 and FIGS. 4-6. For example, the memory 144 has instructions encoded thereon that, when executed by the processor 142, cause the processor 142 to display information related to an item in a physical retail store 104 based on contextual information associated with a shopping cart system 150. Additionally, the online concierge system 102 includes a communication interface configured to connect the online concierge system 102 to one or more networks, such as network 120, or to otherwise communicate with devices (e.g., client devices 110) connected to the network(s).

One or more physical retail stores 104 may be coupled to the network 120 for communicating various types of information with the online concierge system 102, the client device(s) 110, or the third-party system(s) 130. In some embodiments, a physical retail store 104 (e.g., a physical grocery store) communicates a planogram associated with the physical retail store 104, in which the planogram indicates a placement of each item (e.g., each retail product) within the physical retail store 104, as well as a layout of the physical retail store 104. For example, a planogram associated with a physical retail store 104 may indicate the placement of items on shelves, in display cases, in aisles, or within any other suitable organizational elements that are used to organize the items within the physical retail store 104. In this example, the planogram also may include a layout of the physical retail store 104, which describes the location of these organizational elements relative to each other and to building elements of the physical retail store 104 (e.g., walls, doors, stairs, elevators, etc.). In some embodiments, a physical retail store 104 also may communicate updates to a planogram of the physical retail store 104 to the online concierge system 102, the client device(s) 110, and/or the third-party system(s) 130 (e.g., periodically, upon updating the placement of an item within the physical retail store 104 or a layout of the physical retail store 104, etc.). A planogram associated with a physical retail store 104 may be used to identify one or more items within a threshold distance of a shopping cart 156 in the physical retail store 104 and/or to detect an event within the physical retail store 104, as further described below.

A physical retail store 104 may include one or more shopping cart systems 150 capable of collecting information as well as transmitting and/or receiving data via the network 120. Each shopping cart system 150 within the physical retail store 104 may include one or more processors 152 configured to control operation of the shopping cart system 150 by performing various functions. In various embodiments, each shopping cart system 150 also includes a memory 154 comprising a non-transitory storage medium on which instructions are encoded. The memory 154 may have instructions encoded thereon corresponding to some of the modules further described below in conjunction with FIG. 3 that, when executed by the processor 152, cause the processor 152 to perform some of the functionality further described below in conjunction with FIG. 2 and FIGS. 4-6.

Each shopping cart system 150 within a physical retail store 104 also may include a shopping cart 156 that customers of the physical retail store 104 or shoppers for the online concierge system 102 may use to carry items they have collected during a shopping session. In some embodiments, a shopping cart 156 is a wheeled cart made of plastic, metal, or any other suitable material or combination of materials. In various embodiments, a shopping cart system 150 alternatively may include a shopping basket, a mobility scooter, a hand truck, a utility cart, or any other object that may be used to carry items collected during a shopping session.

Each shopping cart system 150 within a physical retail store 104 also may include various sensors 158 for collecting contextual information associated with a shopping cart 156 included in the shopping cart system 150. Contextual information associated with a shopping cart 156 may describe one or more locations of the shopping cart 156 within a physical retail store 104, a state of the shopping cart 156, and/or a set of items within the shopping cart 156. The state of a shopping cart 156 may indicate whether the shopping cart 156 is moving or stationary. In some embodiments, the state of a shopping cart 156 also or alternatively may indicate whether the shopping cart 156 is moving less than a threshold speed, whether the shopping cart 156 has moved less than a threshold distance within a specified amount of time, whether the shopping cart 156 has reversed directions, a velocity of the shopping cart 156, an orientation of the shopping cart 156, or any other suitable information describing a state of the shopping cart 156. In some embodiments, the sensors 158 may be mounted on the shopping cart 156 (e.g., along the periphery of the shopping cart 156). In embodiments in which a shopping cart system 150 includes an object other than a shopping cart 156 (e.g., a shopping basket, a mobility scooter, etc.), the sensors 158 may collect contextual information associated with the object and may be mounted on the object (e.g., along the periphery of a shopping basket).

In some embodiments, one or more sensors 158 included in a shopping cart system 150 may be capable of identifying physical objects within a physical retail store 104 (e.g., via machine vision, object recognition sensors 158, etc.). For example, sensors 158 mounted on a shopping cart 156 may include one or more cameras (e.g., video cameras or digital cameras that capture still images) facing the interior of the shopping cart 156 that are capable of identifying items (e.g., retail products) added to the shopping cart 156. In the above example, sensors 158 mounted on the shopping cart 156 also may include one or more cameras facing out of the shopping cart 156 that are capable of identifying items on shelves, in display cases, in aisles, or within any other suitable organizational elements that are used to organize items within the physical retail store 104. Additionally, in the above example, the cameras facing out of the shopping cart 156 also may be capable of identifying the organizational elements and building elements of the physical retail store 104 (e.g., walls, doors, stairs, elevators, etc.). In some embodiments, the sensors 158 have various capabilities to help identify items, organizational elements, and/or building elements within a physical retail store 104. For example, if the sensors 158 of a shopping cart system 150 include one or more cameras, the cameras may have features such as face detection, text detection, infrared detection, night vision, motion activation, etc.

One or more sensors 158 included in a shopping cart system 150 may have additional capabilities that collect contextual information associated with a shopping cart 156 (or other object) included in the shopping cart system 150. In some embodiments, the sensor(s) 158 may be capable of collecting the following contextual information associated with a shopping cart 156 (or other object): location information (e.g., GPS coordinates), motion, proximity/distance (e.g., from an item, an organizational element used to organize items, and/or a building element of a physical retail store 104), various wavelengths (e.g., visible light, infrared light, etc.), colors, sound, speed, weight, vibration, etc. For example, a GPS sensor 158 and proximity sensors 158 (e.g., laser or ultrasonic proximity sensors 158) mounted on a shopping cart 156 may collect information describing the location of the shopping cart 156 relative to items, aisles, service counters, etc. within a physical retail store 104. In this example, information describing the location of the shopping cart 156 may include GPS coordinates associated with the shopping cart 156 and a distance (e.g., in feet or meters), a direction (e.g., north, south, east, or west), and an altitude (e.g., in feet or meters) of each item, aisle, service counter, etc. relative to one or more proximity sensors 158 mounted on the shopping cart 156.

Contextual information collected by one or more sensors 158 of each shopping cart system 150 within a physical retail store 104 may be associated with various types of data. Examples of data associated with the information include a name of the physical retail store 104, a geographic location associated with the physical retail store 104, a time at which the information was collected at the physical retail store 104, etc. For example, if a physical retail store 104 is a grocery store that belongs to a chain of grocery stores, contextual information collected by sensors 158 included in a shopping cart system 150 in the physical retail store 104 may be associated with data including a name that identifies the chain and a geographic location (e.g., city and state) that identifies the specific physical retail store 104. In the above example, the contextual information also may be associated with a timestamp indicating a time at which it was collected.

In some embodiments, a shopping cart system 150 may include a display area 159 (e.g., a screen mounted to a shopping cart 156 included in the shopping cart system 150). For example, a display area 159 of a shopping cart system 150 may correspond to a touch-screen display that is mounted to a shopping cart 156 of the shopping cart system 150. The display area 159 may be a liquid crystal display (LCD), an in-plane switching liquid crystal display (IPS-LCD), an organic light-emitting diode (OLED), an active-matrix organic light-emitting diode (AMOLED), or any other suitable display type. A display area 159 of a shopping cart system 150 may be used to display a user interface to a customer of a physical retail store 104, as further described below.

In some embodiments, a customer of a physical retail store 104 may interact with a shopping cart system 150. A customer may interact with a shopping cart system 150 to initiate a shopping session and/or to authenticate the user, as further described below. In embodiments in which a shopping cart system 150 includes a display area 159, a customer may interact with the shopping cart system 150 via the display area 159. For example, if a display area 159 of a shopping cart system 150 is a touch-screen display, a customer may initiate a shopping session by touching a button displayed in the display area 159, in which touching the button submits a request to the shopping cart system 150 to initiate a shopping session. The display area 159 may include one or more built-in accessories, such as speakers, microphones, etc. Although not shown in FIG. 1, in some embodiments, a shopping cart system 150 also may include one or more accessories (e.g., speakers, microphones, buttons, dials, knobs, a bar code scanner, a camera, etc.) coupled to a shopping cart 156 included in the shopping cart system 150, which a customer of a physical retail store 104 may use to interact with the shopping cart system 150. For example, if a display area 159 mounted on a shopping cart 156 of a shopping cart system 150 is not a touch-screen display, a customer may initiate a shopping session by pushing a button located beside the display area 159, in which pushing the button submits a request to the shopping cart system 150 to initiate a shopping session. In this example, if the customer pushes the button, a confirmation of the request subsequently may be communicated to the customer (e.g., visually via the display area 159 and audibly via a speaker mounted on the shopping cart 156).

One or more of a client device 110, a third-party system 130, the online concierge system 102, or a shopping cart system 150 may be special-purpose computing devices configured to perform specific functions, as further described below in conjunction with FIGS. 2-6, and may include specific computing components such as processors, memories, communication interfaces, and/or the like.

### System Overview

FIG. 2 illustrates an environment 200 of a shopping cart system 150 and an online platform, such as an online concierge system 102, according to one or more embodiments. The figures use like reference numerals to identify like elements. A letter after a reference numeral, such as “104a,” indicates that the text refers specifically to the element having that particular reference numeral. A reference numeral in the text that is not followed by a letter, such as “104,” refers to any or all of the elements in the figures bearing that reference numeral. For example, “104” in the text may refer to reference numerals “104a,” “104b,” and/or “104c” in the figures.

The environment 200 includes an online concierge system 102. The online concierge system 102 is configured to receive orders from one or more customers 204 (only one is shown for the sake of simplicity). An order specifies a list of goods (items or products) to be delivered to a customer 204, a location to which the goods are to be delivered, and a time window during which the goods should be delivered. In some embodiments, an order specifies one or more retailers from which goods should be purchased. A customer 204 may use a customer mobile application (CMA) 206, which is configured to communicate with the online concierge system 102, to place an order.

The online concierge system 102 is configured to transmit orders received from customers 204 to one or more shoppers 208. A shopper 208 may be a person (e.g., a contractor, an employee, etc.), an entity, or an autonomous device (e.g., a robot) enabled to fulfill orders received by the online concierge system 102. A shopper 208 travels between a physical retail store 104 and a delivery location (e.g., a customer's home or office) and may do so by car, truck, bicycle, scooter, foot, or via any other mode of transportation. In some embodiments, a delivery may be partially or fully automated, e.g., using a self-driving car. The environment 200 also includes three physical retail stores 104a, 104b, and 104c (while only three are shown for the sake of simplicity, the environment 200 may include hundreds of physical retail stores 104). The physical retail stores 104 may be physical retailers, such as grocery stores, discount stores, department stores, etc., or non-public physical retail stores 104 storing items that may be collected and delivered to customers 204. Each shopper 208 fulfills an order received from the online concierge system 102 at one or more physical retail stores 104, delivers the order to a customer 204, or performs both fulfillment and delivery. In one embodiment, shoppers 208 make use of a shopper mobile application 212 which is configured to interact with the online concierge system 102.

One or more physical retail stores 104 within the environment 200 also may include one or more shopping cart systems 150 (only one is shown for the sake of simplicity). A shopping cart system 150 may be configured to communicate various types of information with the online concierge system 102 and/or the CMA 206. Similarly, the online concierge system 102 and/or the CMA 206 may be configured to communicate various types of information with a shopping cart system 150. In various embodiments, a shopping cart system 150 may send a user interface to a display area of a client device 110 associated with a customer 204 (e.g., in a push notification via the CMA 206). In some embodiments, the online concierge system 102 may send a user interface to the shopping cart system 150 to be displayed to a customer 204 of a physical retail store 104.

In some embodiments, a shopping cart system 150 may communicate information to the online concierge system 102 describing a performance metric associated with a content item presented to a customer 204 of a physical retail store 104. A performance metric (e.g., a conversion rate) associated with a content item may indicate whether one or more customers 204 presented with the content item subsequently performed an action associated with the content item. For example, if a content item is associated with a particular item within a physical retail store 104, a performance metric associated with the content item may indicate a rate at which customers 204 presented with the content item subsequently visited an aisle at which the item is located, placed the item in their shopping cart 156, and/or purchased the item.

A shopping cart system 150 within a physical retail store 104 also may communicate contextual information collected by one or more sensors 158 included in the shopping cart system 150 to the online concierge system 102 and/or the CMA 206. For example, suppose that a customer 204 interacts with a shopping cart system 150 to log in to an account associated with the customer 204 maintained in the online concierge system 102. In this example, the shopping cart system 150 may then communicate a route of the customer 204 within a physical retail store 104 based on information describing multiple locations of a shopping cart 156 included in the shopping cart system 150 within the physical retail store 104 during a shopping session. In the above example, the shopping cart system 150 also may communicate locations within the physical retail store 104 at which the shopping cart 156 stopped and information describing items the customer 204 added to the shopping cart 156 and subsequently purchased during the shopping session.

FIG. 3 is a diagram of a shopping cart system 150 and an online concierge system 102, according to one or more embodiments. In various embodiments, a shopping cart system 150 and/or the online concierge system 102 may include different or additional modules than those described in conjunction with FIG. 3. Furthermore, in some embodiments, a shopping cart system 150 and/or the online concierge system 102 include fewer modules than those described in conjunction with FIG. 3.

The online concierge system 102 includes an inventory management engine 302, which interacts with inventory systems associated with each physical retail store 104. In one embodiment, the inventory management engine 302 requests and receives inventory information maintained by a physical retail store 104. The inventory management engine 302 also may receive inventory information from one or more shopping cart systems 150 included in a physical retail store 104, in which the inventory information is collected by one or more sensors 158 included in the shopping cart system(s) 150. The inventory of each physical retail store 104 is unique and may change over time. The inventory management engine 302 monitors changes in inventory for each participating physical retail store 104. The inventory management engine 302 is also configured to store inventory records in an inventory database 304. The inventory database 304 may store information in separate records—one for each participating physical retail store 104—or may consolidate or combine inventory information into a unified record. Inventory information includes attributes of items that include both qualitative and quantitative information about the items, including size, color, weight, SKU, serial number, etc. In one embodiment, the inventory database 304 also stores purchasing rules associated with each item, if they exist. For example, age-restricted items such as alcohol and tobacco are flagged accordingly in the inventory database 304. Additional inventory information useful for predicting the availability of items may also be stored in the inventory database 304. For example, for each item-store combination (a particular item at a particular physical retail store 104), the inventory database 304 may store a time that the item was last found, a time that the item was last not found (e.g., if a shopper 208 looked for the item but could not find it), a rate at which the item is found, and a popularity of the item.

For each item, the inventory database 304 identifies one or more attributes of the item and corresponding values for each attribute of the item. For example, the inventory database 304 includes an entry for each item offered by a physical retail store 104, in which an entry for an item includes an item identifier that uniquely identifies the item. The entry includes different fields, with each field corresponding to an attribute of the item. A field of an entry includes a value for an attribute corresponding to the field, allowing the inventory database 304 to maintain values of different attributes for various items.

In various embodiments, the inventory management engine 302 maintains a taxonomy of items offered for purchase by one or more physical retail stores 104. For example, the inventory management engine 302 receives an item catalog from a physical retail store 104 identifying items offered for purchase by the physical retail store 104. From the item catalog, the inventory management engine 302 determines a taxonomy of items offered by the physical retail store 104, in which different levels of the taxonomy provide different levels of specificity about items included in the levels. In various embodiments, the taxonomy identifies a category and associates one or more specific items with the category. For example, a category identifies “milk,” and the taxonomy associates identifiers of different milk items (e.g., milk offered by different brands, milk having one or more different attributes, etc.) with the category. Thus, the taxonomy maintains associations between a category and specific items offered by the physical retail store 104 matching the category. In some embodiments, different levels of the taxonomy identify items with differing levels of specificity based on any suitable attribute or combination of attributes of the items. For example, different levels of the taxonomy specify different combinations of attributes of items, so items in lower levels of the hierarchical taxonomy have a greater number of attributes, corresponding to greater specificity in a category, while items in higher levels of the hierarchical taxonomy have a fewer number of attributes, corresponding to less specificity in a category. In various embodiments, higher levels of the taxonomy include fewer details about items, so greater numbers of items are included in higher levels (e.g., higher levels include a greater number of items satisfying a broader category). Similarly, lower levels of the taxonomy include greater details about items, so fewer numbers of items are included in the lower levels (e.g., lower levels include a fewer number of items satisfying a more specific category). The taxonomy may be received from a physical retail store 104 in various embodiments. In other embodiments, the inventory management engine 302 applies a trained classification model to an item catalog received from a physical retail store 104 to include different items in levels of the taxonomy, so application of the trained classification model associates specific items with categories corresponding to levels within the taxonomy.

Inventory information provided by the inventory management engine 302 may supplement training datasets 320. Inventory information provided by the inventory management engine 302 may not necessarily include information about the outcome of fulfilling a delivery order associated with the item, whereas the data within the training datasets 320 is structured to include an outcome of fulfilling a delivery order (e.g., if an item in an order was or was not collected).

In some embodiments, the online concierge system 102 includes an order fulfillment engine 306 which is configured to synthesize and display an ordering interface to each customer 204 (for example, via the customer mobile application 206). The order fulfillment engine 306 is also configured to access the inventory database 304 in order to determine which items are available at which physical retail store 104. The order fulfillment engine 306 may supplement the item availability information from the inventory database 304 with item availability information predicted by a machine-learned item availability model 316. The order fulfillment engine 306 determines a sale price for each item ordered by a customer 204. Prices set by the order fulfillment engine 306 may or may not be identical to in-store prices determined by retailers (which is the price that customers 204 and shoppers 208 would pay at the physical retail stores 104). The order fulfillment engine 306 also facilitates transactions associated with each order. In one embodiment, the order fulfillment engine 306 charges a payment instrument associated with a customer 204 when he/she places an order. The order fulfillment engine 306 may transmit payment information to an external payment gateway or payment processor. The order fulfillment engine 306 stores payment and transactional information associated with each order in a transaction records database 308.

In various embodiments, the order fulfillment engine 306 generates and transmits a search interface to a client device 110 of a customer 204 for display via the customer mobile application 206. The order fulfillment engine 306 receives a query comprising one or more terms from a customer 204 and retrieves items satisfying the query, such as items having descriptive information matching at least a portion of the query. In various embodiments, the order fulfillment engine 306 leverages item embeddings for items to retrieve items based on a received query. For example, the order fulfillment engine 306 generates an embedding for a query and determines measures of similarity between the embedding for the query and item embeddings for various items included in the inventory database 304.

In some embodiments, the order fulfillment engine 306 also shares order details with physical retail stores 104. For example, after successful fulfillment of an order, the order fulfillment engine 306 may transmit a summary of the order to the appropriate physical retail stores 104. Details of an order may indicate the items purchased, a total value of the items, and in some cases, an identity of a shopper 208 and a customer 204 associated with the order. In one embodiment, the order fulfillment engine 306 pushes transaction and/or order details asynchronously to retailer systems. This may be accomplished via the use of webhooks, which enable programmatic or system-driven transmission of information between web applications. In another embodiment, retailer systems may be configured to periodically poll the order fulfillment engine 306, which provides details of all orders which have been processed since the last request.

The order fulfillment engine 306 may interact with the shopper management engine 310, which manages communication with and utilization of shoppers 208. In one embodiment, the shopper management engine 310 receives a new order from the order fulfillment engine 306. The shopper management engine 310 identifies the appropriate physical retail store 104 to fulfill the order based on one or more parameters, such as a probability of item availability determined by the machine-learned item availability model 316, the contents of the order, the inventory of the physical retail stores 104, and the proximity of the physical retail stores 104 to the delivery location. The shopper management engine 310 then identifies one or more appropriate shoppers 208 to fulfill the order based on one or more parameters, such as the shoppers' proximity to the appropriate physical retail store 104 (and/or to the customer 204), his/her familiarity level with that particular physical retail store 104, etc. Additionally, the shopper management engine 310 accesses a shopper database 312 which stores information describing each shopper 208, such as his/her name, gender, rating, previous shopping history, etc.

As part of fulfilling an order, the order fulfillment engine 306 and/or shopper management engine 310 may access a customer database 314, which stores information describing each customer 204. In some embodiments, information stored in the customer database 314 describing each customer 204 is included in a user profile of the customer 204. This information may include each customer's name, geographic location (e.g., home or business address), age, gender, shopping preferences, favorite items, dislikes, stored payment instruments, profile picture, etc.

A user profile of a customer 204 stored in the customer database 314 also may include historical information associated with the customer 204. In some embodiments, historical information associated with a customer 204 may describe one or more shopping trips of the customer 204 to a physical retail store 104. In such embodiments, the historical information may be collected by one or more sensors 158 included in a shopping cart system 150 within the physical retail store 104. For example, historical information associated with a customer 204 describing a shopping trip to a physical retail store 104 may include information identifying the physical retail store 104, a time and duration of a shopping session at the physical retail store 104, a route within the physical retail store 104 traveled by the customer 204, amounts of time that the customer 204 stopped at particular locations within the physical retail store 104, information describing each location at which the customer 204 stopped, etc. In this example, the historical information associated with the customer 204 also may include information identifying one or more content items associated with items within the physical retail store 104 sent for display to the customer 204 while at the physical retail store 104, a time at which each content item was sent, and information identifying one or more items associated with each content item. Additionally, in the above example, the historical information associated with the customer 204 may describe interactions by the customer 204 with items at the physical retail store 104 (e.g., picking up an item, placing an item in a shopping cart 156, purchasing an item, etc.) and a time associated with each interaction.

In some embodiments, historical information associated with a customer 204 included in a user profile of the customer 204 also may describe actions performed by the customer 204 within the online concierge system 102. For example, historical information associated with a customer 204 may describe orders placed by the customer 204 using the online concierge system 102 (e.g., descriptions of items included in each order, a time at which each order was placed, information identifying a physical retail store 104 with which each order was placed, etc.). In this example, historical information associated with the customer 204 also may indicate whether the customer 204 viewed information associated with an item (e.g., product information, ingredient list, etc.). Additionally, in the above example, historical information associated with the customer 204 also may describe one or more content items sent for display to the customer 204 by the online concierge system 102 (e.g., information identifying each content item, a time at which each content item was sent, information indicating whether the customer 204 interacted with each content item, and information identifying one or more items associated with each content item).

In some embodiments, user profile information associated with a customer 204 may be stored in multiple databases. For example, in addition to the customer database 314, historical information associated with a customer 204 also may be stored in the transaction records database 308 and/or the training datasets 320. In such embodiments, the information included in the user profile of a customer 204 may be identified based on information identifying the customer 204 (e.g., a username or other identifier of the customer 204) associated with the information. Furthermore, in some embodiments, user profile information associated with a customer 204 also may be stored in one or more databases in the shopping cart system 150 (e.g., in the event database 324, in the context database 330 and/or the attribution database 338), as further described below.

In various embodiments, the order fulfillment engine 306 determines whether to delay display of a received order to shoppers 208 for fulfillment by a time interval. In response to determining to delay display of the received order by a time interval, the order fulfilment engine 306 evaluates subsequent orders received during the time interval for inclusion in one or more batches that also include the received order. After the time interval, the order fulfillment engine 306 displays the order to one or more shoppers 208 via the shopper mobile application 212; if the order fulfillment engine 306 generated one or more batches including the received order and one or more subsequent orders received during the time interval, the batch(es) is/are also displayed to one or more shoppers 208 via the shopper mobile application 212.

### Shopping Cart System Components

The shopping cart system 150 includes an event detection engine 322, which detects various types of events associated with a customer 204 within a physical retail store 104. Examples of events that may be detected by the event detection engine 322 include the initiation of a shopping session within a physical retail store 104 by a customer 204 of the physical retail store 104, stopping a shopping cart 156 within a threshold distance of an item within the physical retail store 104 for at least a threshold amount of time, moving a shopping cart 156 within a threshold distance of an item within the physical retail store 104, picking up an item from a specific location within the physical retail store 104 (e.g., a promotional display area), adding an item to a shopping cart 156, purchasing an item from the physical retail store 104, concluding a shopping session, or any other types of events that may be associated with a customer 204 within a physical retail store 104. For example, the event detection engine 322 may detect the initiation of a shopping session by a customer 204 of a physical retail store 204 upon receiving a reading from one or more sensors 158 (e.g., motion or velocity sensors 158) of a shopping cart system 150 or upon receiving one or more interactions by the customer 204 with a display area 159 and/or one or more accessories (e.g., buttons, dials, knobs, microphones, a bar code scanner, a camera, etc.) included in the shopping cart system 150 corresponding to a request to initiate a shopping session. Similarly, the event detection engine 322 may detect the conclusion of a shopping session upon receiving no reading from one or more sensors 158 (e.g., motion or velocity sensors 158) included in the shopping cart system 150 for at least a threshold amount of time or upon receiving one or more interactions by a customer 204 with a display area 159 and/or one or more accessories included in the shopping cart system 150 corresponding to a request to conclude a shopping session. In embodiments in which an event detected by the event detection engine 322 corresponds to stopping a shopping cart 156 within a threshold distance of an item within a physical retail store 104 for at least a threshold amount of time, the threshold amount of time and/or distance may be determined by a machine-learned model (e.g., a model trained based on anonymous aggregated data describing customer behavior associated with shopping carts 156 when deciding whether to purchase items).

In some embodiments, a shopping session may be initiated upon authentication of a customer 204. In such embodiments, information provided by the customer 204 may be used by the event detection engine 322 and/or the online concierge system 102 to authenticate the customer 204. Examples of such information include a username and password combination, biometric information (e.g., a fingerprint), or any other suitable information that may be used to authenticate the customer 204. For example, information from a customer 204 corresponding to login credentials for the online concierge system 102 may be received by the event detection engine 322 via a touch-screen display area 159 included in the shopping cart system 150. In this example, the event detection engine 322 may communicate the login credentials to the online concierge system 102, which may authenticate the customer 204 if the credentials match those of a customer 204 of the online concierge system 102 stored in the customer database 314. Alternatively, in the above example, the event detection engine 322 may access the customer database 314 of the online concierge system 102 and authenticate the customer 204 if the credentials match those of a customer 204 of the online concierge system 102 stored in the customer database 314. As an additional example, a quick response (QR) code that uniquely identifies a customer 204 in the online concierge system 102 may be generated by the online concierge system 102 and displayed on a client device 110 associated with the customer 204 (e.g., via the CMA 206). In this example, the customer 204 may be authenticated if a camera included in the shopping cart system 150 scans the QR code and the event detection engine 322 communicates the QR code to the online concierge system 102, which then authenticates the customer 204. In embodiments in which a shopping session is initiated upon authentication of a customer 204, the shopping session may be linked to a user profile of the customer 204 upon authentication of the customer 204. For example, once a customer 204 is authenticated, information describing a shopping session may be stored in the event database 324 (described below) and included among user profile information associated with the customer 204.

The event detection engine 322 may detect an event associated with a customer 204 at a physical retail store 104 based on contextual information associated with a shopping cart 156 tracked by the context tracking engine 328, described below, and/or a planogram associated with the physical retail store 104 stored in the planogram database 326, also described below. For example, suppose that a particular item is placed in two different locations within a physical retail store 104, in which one location is its normal location within an aisle and the other location is a promotional display area at the end of a different aisle. In this example, the event detection engine 322 may detect an event corresponding to adding the item to a shopping cart 156 included in the shopping cart system 150, in which the event detection engine 322 also detects the location at which the item was added to the shopping cart 156 (e.g., based on the planogram associated with the physical retail store 104). As an additional example, the event detection engine 322 may detect the conclusion of a shopping session based on contextual information tracked by the context tracking engine 328 indicating a shopping cart 156 included in the shopping cart system 150 is within a threshold distance of a shopping cart return area or that the shopping cart 156 has passed through a checkout line within a physical retail store 104.

The event detection engine 322 may store information describing one or more events associated with one or more customers 204 of a physical retail store 104. In some embodiments, this information may be stored in the event database 324 of the shopping cart system 150. In various embodiments, this information also or alternatively may be communicated to and stored in the online concierge system 102 (e.g., in the transaction records database 308 and/or the training datasets 320). The event detection engine 322 may store information describing an event in association with information identifying a customer 204 associated with the event (e.g., based on login credentials provided by the customer 204), information identifying a physical retail store 104 at which the event was detected, a time at which the event was detected, a location within the physical retail store 104 at which the event was detected, or any other information associated with the event. For example, suppose that the event detection engine 322 detects that a customer 204 added an item to a shopping cart 156 included in the shopping cart system 150 while shopping at a physical retail store 104. In this example, information describing the event, such as the type of event (i.e., adding an item to the shopping cart 156) and information describing the item (e.g., the type of item, a size of the item, a brand of the item, etc.) may be stored (e.g., in the event database 324, the transaction records database 308, and/or the training datasets 320). In the above example, the information describing the event may be stored in association with information identifying the physical retail store 104 (e.g., its name and address), a time at which the item was added to the shopping cart 156, an aisle within the physical retail store 104 in which the customer 204 added the item to the shopping cart 156, and a username associated with the customer 204 in the online concierge system 102.

In some embodiments, the shopping cart system 150 further includes a planogram database 326. The planogram database 326 stores one or more planograms that each are associated with a physical retail store 104 and describes the placement of each of multiple items within the physical retail store 104. A planogram associated with a physical retail store 104 may indicate the placement of items on shelves, in display cases, in aisles, or within any other suitable organizational elements that are used to organize the items within the physical retail store 104. A planogram also may include a layout of a physical retail store 104, which describes the location of organizational elements relative to each other and to building elements of the physical retail store 104 (e.g., walls, doors, stairs, elevators, etc.). In some embodiments, a planogram of a physical retail store 104 stored in the planogram database 326 may be updated (e.g., periodically, upon updating the placement of an item within the physical retail store 104 or a layout of the physical retail store 104, etc.). In some embodiments, the planogram database 326 also or alternatively may be included in the online concierge system 102. In such embodiments, a planogram of a physical retail store 104 may be updated by the online concierge system 102 upon receiving information from the physical retail store 104 describing the update.

The shopping cart system 150 further includes a context tracking engine 328. The context tracking engine 328 tracks contextual information associated with a shopping cart 156 (or a similar object used to carry items collected during a shopping session) included in the shopping cart system 150, in which the contextual information is received by one or more sensors 158 included in the shopping cart system 150. As described above, one or more sensors 158 included in the shopping cart system 150 may be capable of identifying physical objects (e.g., items, organizational elements, and/or building elements) within a physical retail store 104. As also described above, contextual information associated with a shopping cart 156 may describe one or more locations of the shopping cart 156 within a physical retail store 104 and/or a set of items within the shopping cart 156. For example, contextual information associated with the shopping cart 156 describing a location of the shopping cart 156 within a physical retail store 104 may include GPS coordinates collected by a GPS sensor 158 coupled to the shopping cart 156. In this example, contextual information collected by one or more proximity sensors 158 coupled to the shopping cart 156 also may include a distance (e.g., in feet or meters), a direction (e.g., north, south, east, or west), and an altitude (e.g., in feet or meters) of one or more items, aisles, service counters, etc. within the physical retail store 104 relative to the shopping cart 156. Continuing with this example, contextual information collected by sensors 158 (e.g., cameras) mounted onto the shopping cart 156 that face the interior of the shopping cart 156 also may include information identifying one or more items (e.g., retail items) within the shopping cart 156.

In some embodiments, the context tracking engine 328 may track contextual information associated with a shopping cart 156 within a physical retail store 104 by comparing information collected by one or more sensors 158 included in the shopping cart system 150 to a planogram associated with the physical retail store 104. For example, if one or more sensors 158 included in the shopping cart system 150 correspond to one or more cameras, the context tracking engine 328 may compare video or image data collected by the cameras to the planogram associated with a physical retail store 104 and determine the location of the shopping cart 156 based on the comparison. In this example, if items identified in the video or image data and their placement within the physical retail store 104 have at least a threshold measure of similarity to a portion of the planogram, the context tracking engine 328 may determine that the shopping cart 156 is at the location within the physical retail store 104 corresponding to the portion of the planogram.

Contextual information associated with a shopping cart 156 tracked by the context tracking engine 328 also may describe a state of the shopping cart 156. As described above, the state of a shopping cart 156 may indicate whether the shopping cart 156 is moving or stationary. In some embodiments, the state of a shopping cart 156 also may indicate whether the shopping cart 156 is moving less than a threshold speed, whether the shopping cart 156 has moved less than a threshold distance within a specified amount of time, whether the shopping cart 156 has reversed directions, a velocity of the shopping cart 156, an orientation of the shopping cart 156, or any other suitable information describing a state of the shopping cart 156.

Contextual information tracked by the context tracking engine 328 may be associated with various types of data. Examples of data that may be associated with the contextual information include a name of a physical retail store 104 at which the contextual information was collected, a geographic location associated with the physical retail store 104, a time at which the information was collected at the physical retail store 104, information describing a shopping session (e.g., time of day) during which the contextual information was collected, information identifying a customer 204 associated with the shopping session (e.g., based on information provided to authenticate the customer 204), etc. For example, if a physical retail store 104 is a grocery store that belongs to a chain of grocery stores, contextual information tracked by the context tracking engine 328 may be associated with data including a name that identifies the chain and a geographic location (e.g., city and state) that identifies the specific physical retail store 104. In the above example, the contextual information also may be associated with a timestamp indicating a time at which it was collected by sensors 158 included in the shopping cart system 150.

In some embodiments, the context tracking engine 328 may store contextual information it tracks and/or data associated with the contextual information in the context database 330. In embodiments in which contextual information stored in the context database 330 includes information identifying a customer 204 associated with the contextual information, this information may be included in a user profile associated with the customer 204. For example, if a customer 204 provides information that uniquely identifies the customer 204 upon initiating a shopping session and the information is used to authenticate the customer 204, information identifying the customer 204 (e.g., a username) may be stored in the context database 330 in association with contextual information tracked by the context tracking engine 328 during the shopping session. In this example, the contextual information may later be retrieved in association with other user profile information associated with the customer 204.

In various embodiments, the context tracking engine 328 also may communicate contextual information it tracks and/or data associated with the contextual information to the online concierge system 102. In such embodiments, the online concierge system 102 may use this information for various purposes. In some embodiments, the online concierge system 102 may use this information to customize an experience of a customer 204 in the online concierge system 102. For example, if a customer 204 of a physical retail store 104 is also a customer 204 of the online concierge system 102, the online concierge system 102 may customize an online version of the physical retail store 104 based on a route commonly traversed by the customer 204 through the physical retail store 104.

The shopping cart system 150 further includes a user interface engine 332. The user interface engine 332 identifies an opportunity to present content to a customer 204 of a physical retail store 104 based in part on contextual information associated with a shopping cart 156 included in the shopping cart system 150. In various embodiments, the user interface engine 332 may receive contextual information associated with a shopping cart 156 from the context tracking engine 328, while in other embodiments, the user interface engine 332 may retrieve the contextual information from the context database 330. In some embodiments, the user interface engine 332 may identify an opportunity to present content to a customer 204 upon detecting that a shopping cart 156 has been stationary for at least a threshold amount of time. For example, the user interface engine 332 may receive contextual information from the context tracking engine 328 describing a state of the shopping cart 156 being used during a shopping session associated with a customer 204 of a physical retail store 104. In this example, if the contextual information indicates that the shopping cart 156 has been stationary for at least a threshold amount of time, the user interface engine 332 may identify an opportunity to present content to the customer 204. In some embodiments, the user interface engine 332 also or alternatively may identify an opportunity to present content to a customer 204 upon detecting one or more specific items within a shopping cart 156. For example, if the contextual information indicates that an item has been added to a shopping cart 156, the user interface engine 332 may identify an opportunity to present content associated with the item to the customer 204.

The user interface engine 332 also identifies a set of content items associated with one or more items within a physical retail store 104 to include in a user interface to be sent for display to a customer 204 of the physical retail store 104. In some embodiments, the user interface engine 332 may identify the set of content items using a machine-learned model. Furthermore, the user interface engine 332 may identify the set of content items based in part on contextual information associated with a shopping cart 156 included in the shopping cart system 150. In embodiments in which the user interface engine 332 identifies an opportunity to present content to a customer 204 upon detecting that a shopping cart 156 has been stationary for at least a threshold amount of time, a set of content items identified by the user interface engine 332 may be associated with one or more items within a threshold distance of the shopping cart 156. For example, the user interface engine 332 may access contextual information stored in the context database 330 describing a location of a shopping cart 156 within a physical retail store 104 while the shopping cart 156 has been stationary for at least a threshold amount of time. In this example, the user interface engine 332 may then access the planogram database 326 to retrieve a planogram associated with the physical retail store 104 and compare the location of the shopping cart 156 to the planogram. Continuing with this example, the user interface engine 332 may then identify one or more items within the physical retail store 104 within a threshold distance of the location of the shopping cart 156 and access the content database 334 (described below) to identify one or more content items associated with the identified item(s). In embodiments in which the user interface engine 332 identifies an opportunity to present content to a customer 204 upon detecting one or more specific items within a shopping cart 156, a set of content items identified by the user interface engine 332 may be associated with the item(s). For example, upon detecting that an item has been added to a shopping cart 156 (e.g., by the event detection engine 322), the user interface engine 332 may access contextual information stored in the context database 330 describing one or more items within the shopping cart 156. In this example, if the contextual information indicates that an item within the shopping cart 156 is spaghetti, the user interface engine 332 may identify a set of content items associated with spaghetti.

In some embodiments, the user interface engine 332 also may identify a set of content items associated with one or more items within a physical retail store 104 to include in a user interface to be sent for display to a customer 204 of the physical retail store 104 based in part on user profile information associated with the customer 204. In such embodiments, the user interface engine 332 may identify the set of content items based on the customer's geographic location, age, gender, shopping preferences, favorite items, dislikes, historical information associated with the customer 204 (e.g., in a physical retail store 104 or the online concierge system 102), or any other information included in the customer's user profile. For example, suppose that a user profile of a customer 204 indicates that the customer 204 dislikes nuts because they are allergic to them. In this example, if one or more sensors 158 of the shopping cart system 150 identify an item added to a shopping cart 156 being used by the customer 204 and the item includes an ingredient corresponding to a nut, a content item including a warning about the contents of the item may be identified by the user interface engine 332. As an additional example, suppose that historical information associated with a customer 204 indicates that the customer 204 usually purchases a particular item during each shopping session or according to a consistent cadence, such that the customer 204 is likely to purchase the item during a current shopping session. In this example, if contextual information associated with a shopping cart 156 included in the shopping cart system 150 being used by a customer 204 indicates that the shopping cart 156 is in a checkout line and the item is not within the shopping cart 156, a content item reminding the customer 204 about the item may be identified by the user interface engine 332. In embodiments in which the user interface engine 332 identifies content items based on user profile information associated with a customer 204, the user interface engine 332 may access user profile information stored in the online concierge system 102 (e.g., in the customer database 314, in the transaction records database 308, and/or the training datasets 320) and/or the online concierge system 102 may communicate the user profile information to the user interface engine 332.

In various embodiments, the user interface engine 332 also may identify a set of content items associated with one or more items within a physical retail store 104 to include in a user interface to be sent for display to a customer 204 of the physical retail store 104 based in part on a time of a shopping session. In such embodiments, the user interface engine 332 may identify a content item included among the set based on seasonal demand for an item associated with the content item, a day of the week, a time of day, etc. For example, during early-morning shopping sessions, the user interface engine 332 may identify one or more content items associated with breakfast items (e.g., pastries, coffee, tea, etc.). As an additional example, a month prior to Thanksgiving, the user interface engine 332 may identify content items associated with items related to Thanksgiving (e.g., Thanksgiving recipes, promotions for ham or gravy, etc.).

In some embodiments, the user interface engine 332 also may identify a set of content items associated with one or more items within a physical retail store 104 to include in a user interface to be sent for display to a customer 204 of the physical retail store 104 based in part on information associated with the set of content items and/or information associated with one or more items associated with the content items. In various embodiments, each content item may be associated with a value that the user interface engine 332 may use to identify the set of content items to include in the user interface, such that content items associated with higher values are more likely to be identified by the user interface engine 332 than content items associated with lower values. For example, if content items correspond to advertisements, content items associated with higher bid amounts may be more likely to be identified by the user interface engine 332 for inclusion in the user interface than content items associated with lower bid amounts. As an additional example, content items associated with higher-priced items and/or items with higher inventory counts may be more likely to be identified by the user interface engine 332 for inclusion in the user interface than content items associated with lower-priced items and/or items with lower inventory counts.

In some embodiments, the user interface engine 332 also may identify a set of content items associated with one or more items within a physical retail store 104 to include in a user interface to be sent for display to a customer 204 of the physical retail store 104 based in part on information received from the online concierge system 102. For example, suppose that the online concierge system 102 presents various content items (e.g., articles, recipes, etc.) to its customers 204 via the CMA 206. In this example, the online concierge system 102 may communicate information to the user interface engine 332 identifying certain content items that are trending among customers 204 of the online concierge system 102. In the above example, the trending content items may be identified by the user interface engine 332 for inclusion in a user interface to be sent for display to a customer 204 of a physical retail store 104 (e.g., if contextual information associated with a shopping cart 156 used by the customer 204 indicates the shopping cart 156 is within a threshold distance of one or more items associated with the trending content items).

In some embodiments, the user interface engine 332 may not identify a content item associated with an item within a physical retail store 104 to include in a user interface to be sent for display to a customer 204 based on a type associated with the content item and contextual information associated with a shopping cart 156. In various embodiments, the user interface engine 332 may not identify a content item if the content item is unlikely to encourage a customer 204 to perform an action associated with an item (e.g., to purchase the item). For example, suppose that a content item corresponds to an advertisement for spaghetti sauce and contextual information associated with a shopping cart 156 being used by a customer 204 within a physical retail store 104 indicates that spaghetti sauce is included among the items within the shopping cart 156. In this example, the content item may not be included among a set of content items identified by the user interface engine 332 to include in a user interface to be sent for display to the customer 204 since the customer 204 is already likely to purchase the spaghetti sauce if it is in their shopping cart 156. However, in the above example, if the content item is a coupon for the spaghetti sauce, the content item may be included among the set of content items identified by the user interface engine 332 since the customer 204 is more likely to purchase more of the spaghetti sauce with the coupon.

Once the user interface engine 332 identifies a set of content items associated with one or more items within a physical retail store 104 to include in a user interface to be sent for display to a customer 204 of the physical retail store 104, the user interface engine 332 also generates the user interface including the set of content items. For example, if the user interface engine 332 identifies multiple content items, the user interface engine 332 may generate a user interface with the content items organized in a grid format or in a horizontally or vertically scrollable carousel format. In embodiments in which the user interface engine 332 identifies multiple content items to include in a user interface to be sent for display to a customer 204, the content items may be arranged based on a likelihood that the customer 204 subsequently will perform an action associated with each content item. For example, if a user interface includes multiple content items, a content item associated with an action that a customer 204 is most likely to perform is arranged in a most prominent position of the user interface and a content item associated with an action that the customer 204 is least likely to perform is arranged in a least prominent position. In such embodiments, the user interface engine 332 may determine the likelihood associated with each content item based on information included in a user profile of the customer 204. For example, the user interface engine 332 may determine a likelihood that a customer 204 will perform an action associated with a content item based on information included in a user profile of the customer 204 maintained in the attribution database 338 (described below). In this example, the information included in the user profile may describe whether events associated with similar actions performed by the customer 204 were attributed to including similar content items in a user interface previously sent to a display area associated with the customer 204.

Once the user interface engine 332 generates a user interface, the user interface engine 332 sends the user interface to a display area associated with a customer 204. In some embodiments, the user interface engine 332 sends the user interface to a display area included in a client device 110 associated with a customer 204. In various embodiments, the user interface engine 332 also or alternatively sends the user interface to a display area 159 included in the shopping cart system 150.

The shopping cart system 150 further includes a content database 334. The content database 334 stores content items associated with items within one or more physical retail stores 104. The content database 334 may store various types of content items, such as product information associated with an item (e.g., source/manufacturing information, warnings about materials/ingredients), a promotion for an item, a coupon for an item, a set of instructions for using an item, a suggested use for an item, an advertisement for an item, a reminder about an item, a video, an image, or a social media post that features an item, etc. For example, if an item is a retail item sold at a grocery store, a content item corresponding to product information associated with the item may include nutritional information associated with the item, information indicating whether the item is organic, where it is made, etc. As an additional example, a content item associated with an item in a grocery store may correspond to a recipe in which the item is included as an ingredient. As yet another example, a content item associated with an item may correspond to a reminder to purchase the item if a customer 204 often purchases the item during shopping sessions or if the item is commonly paired with another item that is in a shopping cart 156 being used by a customer 204. In some embodiments, one or more content items stored in the content database 334 may be associated with multiple items within a physical retail store 104. For example, a content item corresponding to a recipe may be associated with multiple items that each correspond to an ingredient for the recipe.

The shopping cart system 150 further includes an attribution engine 336. The attribution engine 336 determines whether to attribute an event detected by the event detection engine 322 to including a content item in a user interface sent for display to a customer 204 of a physical retail store 104. The attribution engine 336 may make the determination based on a first time at which the user interface was sent to a display area associated with the customer 204 and a second time at which the event was detected by the event detection engine 322. In some embodiments, once a user interface is sent to a display area associated with a customer 204 during a shopping session, the attribution engine 336 may determine that any subsequent events detected by the event detection engine 322 during the shopping session may be attributed to including a content item associated with the event in the user interface. For example, suppose that the user interface engine 332 sends a user interface to a display area associated with a customer 204, in which the user interface includes a content item corresponding to a coupon for an item. In this example, the attribution engine 336 may determine that the addition of the item to a shopping cart 156 by the customer 204 and the purchase of the item by the customer 204 subsequently detected by the event detection engine 322 should be attributed to including the content item in the user interface sent for display to the customer 204.

In some embodiments, once the attribution engine 336 determines whether to attribute an event detected by the event detection engine 322 to including a content item in a user interface sent for display to a customer 204 of a physical retail store 104, the attribution engine 336 may store information describing the determination in the attribution database 338. Information stored in the attribution database 338 may include information describing a content item included in a user interface sent to a display area associated with a customer 204 of a physical retail store 104, information describing a time at which the user interface was sent to the display area, information describing the display area (e.g., whether the display area is included in a client device 110 or the shopping cart system 150), information identifying the customer 204, information describing an event that was or was not attributed to including the content item in the user interface (e.g., a time at which the event was detected, information identifying an item associated with the event, etc.), or any other suitable information describing a determination made by the attribution engine 336. In embodiments in which information stored in the attribution database 338 includes information identifying a customer 204, the information may be included among user profile information associated with the customer 204.

In some embodiments, the shopping cart system 150 further includes a performance engine 340. The performance engine 340 computes a performance metric associated with a content item based in part on a determination by the attribution engine 336 whether to attribute an event to including the content item in a user interface sent to a display area associated with a customer 204 of a physical retail store 104. The performance metric may correspond to a conversion rate, a click-through rate (CTR), or any other suitable metric that describes a performance of a content item. For example, a performance metric associated with a content item may correspond to a conversion rate, in which the conversion rate describes a rate at which customers 204 of a physical retail store 104 presented with the content item during their shopping sessions subsequently added an item associated with the content item to their shopping carts 156. As an additional example, a performance metric associated with a content item may correspond to a click-through rate, in which the click-through rate describes a rate at which customers 204 presented with the content item clicked on the content item to view a recipe associated with an item. The performance engine 340 may be configured to store information describing a performance metric in the performance database 342. Furthermore, in some embodiments, the performance engine 340 and/or the performance database 342 also or alternatively may be included in the online concierge system 102. In embodiments in which the performance engine 340 is included in the online concierge system 102, a determination by the attribution engine 336 whether to attribute an event to including a content item in a user interface sent to a display area associated with a customer 204 may be communicated to the online concierge system 102 and used by the performance engine 340 to compute a performance metric associated with the content item. In such embodiments, the performance engine 340 of the online concierge system 102 may access the attribution engine 336 of the shopping cart system 150 to retrieve the determination or the attribution engine 336 of the shopping cart system 150 may communicate the determination to the performance engine 340 of the online concierge system 102.

Displaying Information Related to an Item in a Physical Retail Store Based on Contextual Information Associated with a Shopping Cart System

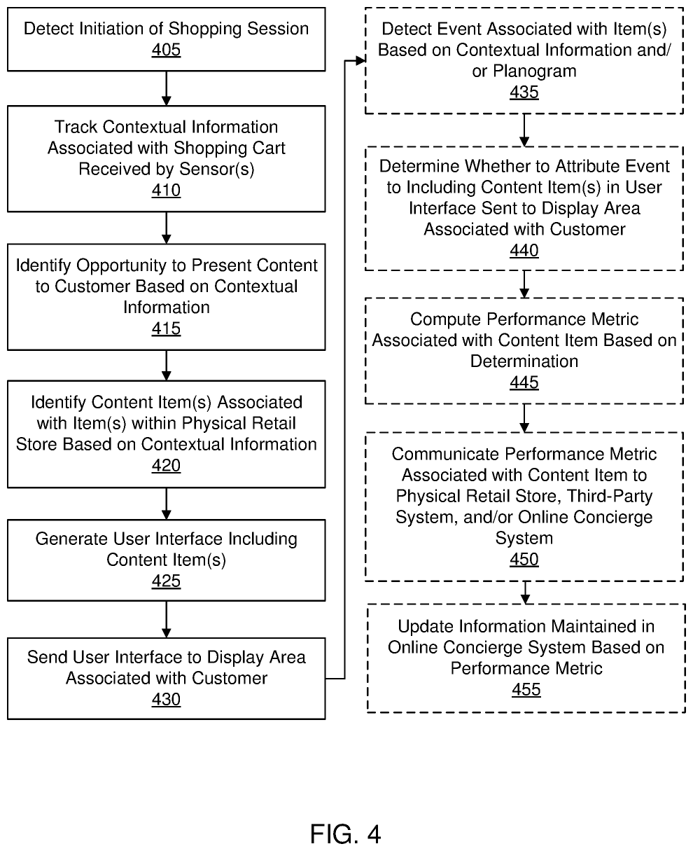

FIG. 4 is a flowchart of a method for displaying information related to an item in a physical retail store 104 based on contextual information associated with a shopping cart system 150, according to one or more embodiments. In various embodiments, the method includes different or additional steps than those described in conjunction with FIG. 4. Further, in some embodiments, the steps of the method may be performed in different orders than the order described in conjunction with FIG. 4. One or more steps of the method described in conjunction with FIG. 4 may be carried out by the online concierge system 102 in various embodiments, while in other embodiments, the steps of the method are performed by any online system capable of retrieving items.

The shopping cart system 150 detects 405 (e.g., via the event detection engine 322) the initiation of a shopping session within a physical retail store 104 by a customer 204 of the physical retail store 104. The initiation of the shopping session may be detected 405 by one or more components of the shopping cart system 150. In some embodiments, the initiation of the shopping session is detected 405 by one or more sensors 158 included in the shopping cart system 150. For example, the shopping cart system 150 may detect 405 the initiation of the shopping session upon receiving a reading from one or more sensors 158 (e.g., motion or velocity sensors 158) of the shopping cart system 150. In various embodiments, the initiation of the shopping session also or alternatively is detected 405 upon receiving one or more interactions with a display area 159 and/or one or more accessories (e.g., buttons, dials, knobs, microphones, a bar code scanner, a camera, etc.) included in the shopping cart system 150. For example, the shopping cart system 150 may detect 405 the initiation of the shopping session by the customer 204 upon receiving a request to initiate the shopping session via a touch-screen display area 159 included in the shopping cart system 150.

In some embodiments, the shopping session may be initiated upon authentication of the customer 204. In such embodiments, information provided by the customer 204 may be used by the shopping cart system 150 and/or the online concierge system 102 to authenticate the customer 204. Examples of such information include a username and password combination, biometric information (e.g., a fingerprint), or any other suitable information that may be used to authenticate the customer 204. For example, information from the customer 204 corresponding to login credentials for the online concierge system 102 may be received by the shopping cart system 150 via a touch-screen display area 159 included in the shopping cart system 150. In this example, the shopping cart system 150 may communicate the login credentials to the online concierge system 102, which may authenticate the customer 204 if the credentials match those of a customer 204 of the online concierge system 102 (e.g., in the customer database 314). Alternatively, in the above example, the shopping cart system 150 may access information maintained in the online concierge system 102 (e.g., in the customer database 314) associated with customers 204 of the online concierge system 102 and authenticate the customer 204 if the credentials match those of a customer 204 of the online concierge system 102. As an additional example, a quick response (QR) code that uniquely identifies the customer 204 in the online concierge system 102 may be generated by the online concierge system 102 and displayed on a client device 110 associated with the customer 204 (e.g., via the CMA 206). In this example, the customer 204 may be authenticated if a camera included in the shopping cart system 150 scans the QR code and the shopping cart system 150 communicates the QR code to the online concierge system 102, which then authenticates the customer 204. In embodiments in which the shopping session is initiated upon authentication of the customer 204, the shopping session may be linked to a user profile of the customer 204 upon authentication of the customer 204. For example, once the customer 204 is authenticated, information describing the shopping session may be stored by the shopping cart system 150 (e.g., in the event database 324) and included among user profile information associated with the customer 204.

The shopping cart system 150 tracks 410 (e.g., using the context tracking engine 328) contextual information associated with a shopping cart 156 (or a similar object used to carry items collected during the shopping session) included in the shopping cart system 150, in which the contextual information is received by one or more sensors 158 included in the shopping cart system 150. As described above, one or more sensors 158 included in the shopping cart system 150 may be capable of identifying physical objects (e.g., items, organizational elements, and/or building elements) within the physical retail store 104. As also described above, contextual information associated with the shopping cart 156 may describe one or more locations of the shopping cart 156 within the physical retail store 104 and/or a set of items within the shopping cart 156. For example, contextual information associated with the shopping cart 156 describing a location of the shopping cart 156 within the physical retail store 104 may include GPS coordinates collected by a GPS sensor 158 coupled to the shopping cart 156. In this example, contextual information collected by one or more proximity sensors 158 coupled to the shopping cart 156 also may include a distance (e.g., in feet or meters), a direction (e.g., north, south, east, or west), and an altitude (e.g., in feet or meters) of one or more items, aisles, service counters, etc. within the physical retail store 104 relative to the shopping cart 156. Continuing with this example, contextual information collected by sensors 158 (e.g., cameras) mounted onto the shopping cart 156 that face the interior of the shopping cart 156 also may include information identifying one or more items (e.g., retail items) within the shopping cart 156.

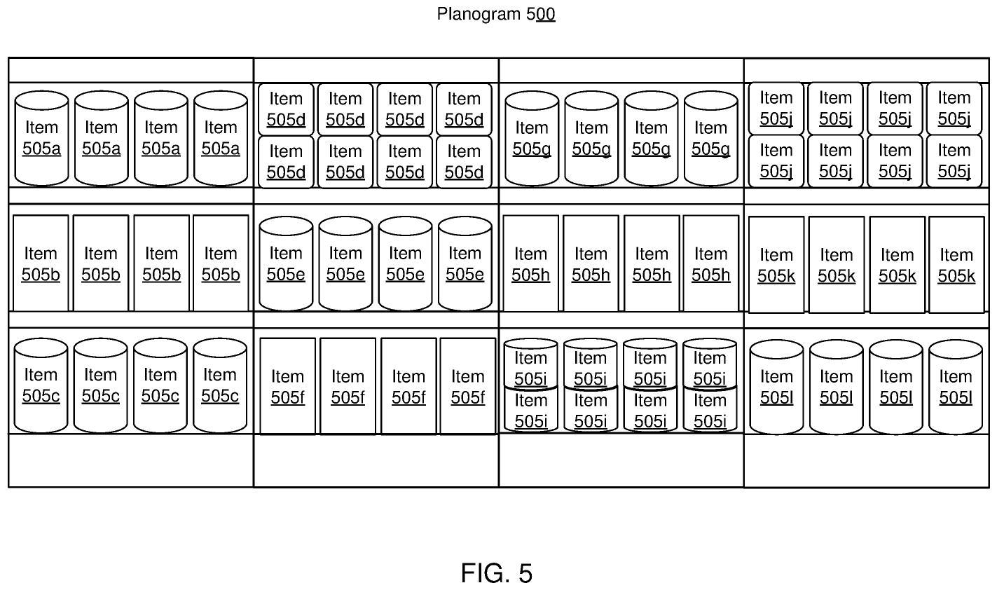

In some embodiments, the shopping cart system 150 may track 410 contextual information associated with the shopping cart 156 by comparing information collected by one or more sensors 158 included in the shopping cart system 150 to a planogram associated with the physical retail store 104. As shown in FIG. 5, which illustrates a planogram 500 associated with a physical retail store 104, according to one or more embodiments, the planogram 500 may indicate the placement of items 505 on shelves, in display cases, in aisles, or within any other suitable organizational elements that are used to organize the items 505 within the physical retail store 104. A planogram 500 also may include a layout of a physical retail store 104, which describes the location of organizational elements relative to each other and to building elements of the physical retail store 104 (e.g., walls, doors, stairs, elevators, etc.). To illustrate an example of how the shopping cart system 150 may track 410 contextual information associated with the shopping cart 156 by comparing information collected by sensors 158 included in the shopping cart system 150 to the planogram 500 associated with the physical retail store 104, suppose that one or more of the sensors 158 correspond to one or more cameras. In this example, the shopping cart system 150 may compare video or image data collected by the cameras to the planogram 500 associated with the physical retail store 104 and determine the location of the shopping cart 156 based on the comparison. In the above example, if items 505 identified in the video or image data and their placement within the physical retail store 104 have at least a threshold measure of similarity to a portion of the planogram 500, the shopping cart system 150 may determine that the shopping cart 156 is at the location within the physical retail store 104 corresponding to the portion of the planogram 500.

Contextual information associated with the shopping cart 156 tracked 410 by the shopping cart system 150 also may describe a state of the shopping cart 156. As described above, the state of the shopping cart 156 may indicate whether the shopping cart 156 is moving or stationary. In some embodiments, the state of the shopping cart 156 also may indicate whether the shopping cart 156 is moving less than a threshold speed, whether the shopping cart 156 has moved less than a threshold distance within a specified amount of time, whether the shopping cart 156 has reversed directions, a velocity of the shopping cart 156, an orientation of the shopping cart 156, or any other suitable information describing a state of the shopping cart 156.

Contextual information associated with the shopping cart 156 tracked 410 by the shopping cart system 150 may be associated with various types of data. Examples of data that may be associated with the contextual information include a name of the physical retail store 104 at which the contextual information was collected, a geographic location associated with the physical retail store 104, a time at which the information was collected at the physical retail store 104, information describing the shopping session (e.g., time of day) during which the contextual information was collected, information identifying the customer 204 associated with the shopping session (e.g., based on information provided to authenticate the customer 204), etc. For example, if the physical retail store 104 is a grocery store that belongs to a chain of grocery stores, contextual information associated with the shopping cart 156 tracked 410 by the shopping cart system 150 may be associated with data including a name that identifies the chain and a geographic location (e.g., city and state) that identifies the specific physical retail store 104. In the above example, the contextual information also may be associated with a timestamp indicating a time at which it was collected by sensors 158 included in the shopping cart system 150.

Although not illustrated in FIG. 4, in some embodiments, the shopping cart system 150 may store contextual information it tracks 410 and/or data associated with the contextual information (e.g., in the context database 330). In embodiments in which contextual information stored in the shopping cart system 150 includes information identifying the customer 204 associated with the contextual information, this information may be included in a user profile associated with the customer 204. For example, if the customer 204 provides information that uniquely identifies the customer 204 upon initiating the shopping session and the information is used to authenticate the customer 204, information identifying the customer 204 (e.g., a username) may be stored in the shopping cart system 150 in association with contextual information tracked 410 by the shopping cart system 150 during the shopping session. In this example, the contextual information may later be retrieved in association with other user profile information associated with the customer 204.

In various embodiments, the shopping cart system 150 also may communicate contextual information it tracks 410 and/or data associated with the contextual information to the online concierge system 102. In such embodiments, the online concierge system 102 may use this information for various purposes. In some embodiments, the online concierge system 102 may use this information to customize an experience of the customer 204 in the online concierge system 102. For example, if the customer 204 of the physical retail store 104 is also a customer 204 of the online concierge system 102, the online concierge system 102 may customize an online version of the physical retail store 104 based on a route commonly traversed by the customer 204 through the physical retail store 104.

Referring back to FIG. 4, the shopping cart system 150 then identifies 415 (e.g., via the user interface engine 332) an opportunity to present content to the customer 204 based in part on the contextual information associated with the shopping cart 156. In some embodiments, the shopping cart system 150 may identify 415 the opportunity to present content to the customer 204 upon detecting that the shopping cart 156 has been stationary for at least a threshold amount of time. For example, the shopping cart system 150 may receive contextual information describing a state of the shopping cart 156. In this example, if the contextual information indicates that the shopping cart 156 has been stationary for at least a threshold amount of time, the shopping cart system 150 may identify 415 the opportunity to present content to the customer 204. In some embodiments, the shopping cart system 150 also or alternatively may identify 415 the opportunity to present content to the customer 204 upon detecting one or more specific items 505 within the shopping cart 156. For example, if the contextual information indicates that an item 505 has been added to the shopping cart 156, the shopping cart system 150 may identify 415 the opportunity to present content associated with the item 505 to the customer 204.

The shopping cart system 150 then identifies 420 (e.g., using the user interface engine 332) a set of content items associated with one or more items 505 within the physical retail store 104 to include in a user interface to be sent for display to the customer 204. In some embodiments, the shopping cart system 150 may identify 420 the set of content items using a machine-learned model. Furthermore, the shopping cart system 150 may identify 420 the set of content items based in part on the contextual information associated with the shopping cart 156.

The set of content items may be of various types that may be maintained by the shopping cart system 150 (e.g., in the content database 334), such as product information associated with an item 505 (e.g., source/manufacturing information, warnings about materials/ingredients), a promotion for an item 505, a coupon for an item 505, a set of instructions for using an item 505, a suggested use for an item 505, an advertisement for an item 505, a reminder about an item 505, a video, an image, or a social media post that features an item 505, etc. For example, if an item 505 is a retail item 505 sold at a grocery store, a content item corresponding to product information associated with the item 505 may include nutritional information associated with the item 505, information indicating whether the item 505 is organic, where it is made, etc. As an additional example, a content item associated with an item 505 in a grocery store may correspond to a recipe in which the item 505 is included as an ingredient. As yet another example, a content item associated with an item 505 may correspond to a reminder to purchase the item 505 if the customer 204 often purchases the item 505 during shopping sessions or if the item 505 is commonly paired with another item 505 that is in the shopping cart 156.

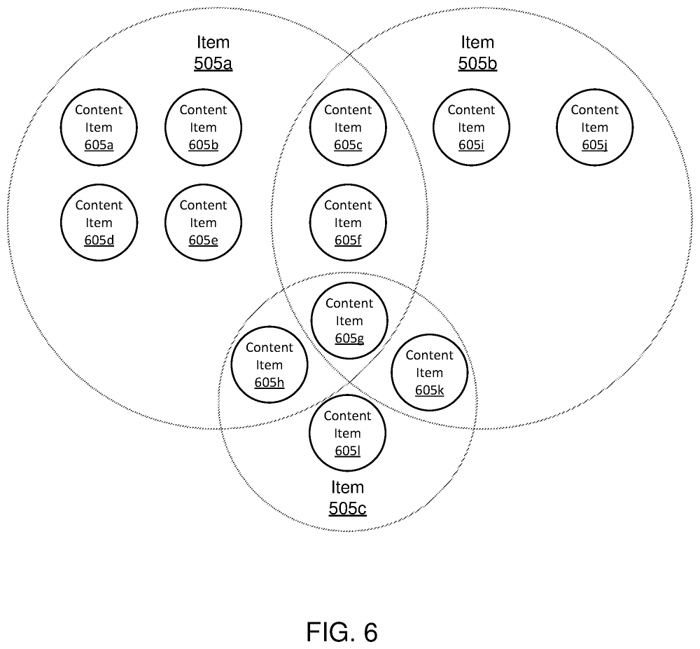

In some embodiments, one or more content items may be associated with multiple items 505 within the physical retail store 104. As shown in FIG. 6, which illustrates content items 605 related to one or more items 505 within a physical retail store 104, according to one or more embodiments, various content items 605 may be associated with one or more items 505. For example, content items 605a, 605b, 605d, and 605e are only associated with item 505a, while content items 605c and 605f are both associated with items 505a and 505b and content item 605g is associated with items 505a, 505b, and 505c.

Referring back to FIG. 4, in embodiments in which the shopping cart system 150 identifies 415 the opportunity to present content to the customer 204 upon detecting that the shopping cart 156 has been stationary for at least a threshold amount of time, the set of content items 605 identified 420 by the shopping cart system 150 may be associated with one or more items 505 within a threshold distance of the shopping cart 156. For example, the shopping cart system 150 may access contextual information stored in the shopping cart system 150 (e.g., in the context database 330) describing a location of the shopping cart 156 within the physical retail store 104 while the shopping cart 156 has been stationary for at least a threshold amount of time. In this example, the shopping cart system 150 may then retrieve a planogram 500 associated with the physical retail store 104 (e.g., from the planogram database 326) and compare the location of the shopping cart 156 to the planogram 500. Continuing with this example, the shopping cart system 150 may then identify one or more items 505 within the physical retail store 104 within a threshold distance of the location of the shopping cart 156 and identify 420 one or more content items 605 associated with the identified item(s) 505 (e.g., by accessing the content database 334).

In embodiments in which the shopping cart system 150 identifies 415 the opportunity to present content to the customer 204 upon detecting one or more specific items 505 within the shopping cart 156, the set of content items 605 identified 420 by the shopping cart system 150 may be associated with the item(s) 505. For example, the shopping cart system 150 may access contextual information (e.g., stored in the context database 330) describing one or more items 505 within the shopping cart 156 upon detecting that an item 505 has been added to the shopping cart 156. In this example, if the contextual information indicates that an item 505 within the shopping cart 156 is spaghetti, the shopping cart system 150 may identify 420 one or more content items 605 associated with spaghetti.

In some embodiments, the shopping cart system 150 also may identify 420 the set of content items 605 to include in the user interface to be sent for display to the customer 204 based in part on user profile information associated with the customer 204. In such embodiments, the shopping cart system 150 may identify 420 the set of content items 605 based on the customer's geographic location, age, gender, shopping preferences, favorite items 505, dislikes, historical information associated with the customer 204 (e.g., in the physical retail store 104 or the online concierge system 102), or any other information included in the customer's user profile. For example, suppose that a user profile of the customer 204 indicates that the customer 204 dislikes nuts because they are allergic to them. In this example, if one or more sensors 158 of the shopping cart system 150 identify an item 505 added to the shopping cart 156 and the item 505 includes an ingredient corresponding to a nut, a content item 605 including a warning about the contents of the item 505 may be identified 420 by the shopping cart system 150. As an additional example, suppose that historical information associated with the customer 204 indicates that the customer 204 usually purchases a particular item 505 during each shopping session or according to a consistent cadence, such that the customer 204 is likely to purchase the item 505 during the current shopping session. In this example, if contextual information associated with the shopping cart 156 indicates that the shopping cart 156 is in a checkout line and the item 505 is not within the shopping cart 156, a content item 605 reminding the customer 204 about the item 505 may be identified 420 by the shopping cart system 150. In embodiments in which the shopping cart system 150 identifies (step 420) content items 605 based on user profile information associated with the customer 204, the shopping cart system 150 may access user profile information stored in the online concierge system 102 (e.g., in the customer database 314, in the transaction records database 308, and/or the training datasets 320) and/or the online concierge system 102 may communicate the user profile information to the shopping cart system 150.

In various embodiments, the shopping cart system 150 also may identify 420 the set of content items 605 to include in the user interface to be sent for display to the customer 204 based in part on a time of the shopping session. In such embodiments, the shopping cart system 150 may identify 420 a content item 605 included among the set based on seasonal demand for an item 505 associated with the content item 605, a day of the week, a time of day, etc. For example, if the shopping session is early in the morning, the shopping cart system 150 may identify 420 one or more content items 605 associated with breakfast items 505 (e.g., pastries, coffee, tea, etc.). As an additional example, if the shopping session occurs a month prior to Thanksgiving, the shopping cart system 150 may identify (step 420) content items 605 associated with items 505 related to Thanksgiving (e.g., Thanksgiving recipes, promotions for ham or gravy, etc.).

In some embodiments, the shopping cart system 150 also may identify 420 the set of content items 605 to include in the user interface to be sent for display to the customer 204 based in part on information associated with the set of content items 605 and/or information associated with one or more items 505 associated with the set of content items 605. In various embodiments, each content item 605 may be associated with a value that the shopping cart system 150 may use to identify 420 the set of content items 605 to include in the user interface, such that content items 605 associated with higher values are more likely to be identified 420 by the shopping cart system 150 than content items 605 associated with lower values. For example, if content items 605 correspond to advertisements, content items 605 associated with higher bid amounts may be more likely to be identified 420 by the shopping cart system 150 for inclusion in the user interface than content items 605 associated with lower bid amounts. As an additional example, content items 605 associated with higher-priced items 505 and/or items 505 with higher inventory counts may be more likely to be identified 420 by the shopping cart system 150 for inclusion in the user interface than content items 605 associated with lower-priced items 505 and/or items 505 with lower inventory counts.

In some embodiments, the shopping cart system 150 also may identify 420 the set of content items 605 to include in the user interface to be sent for display to the customer 204 based in part on information received from the online concierge system 102. For example, suppose that the online concierge system 102 presents various content items 605 (e.g., articles, recipes, etc.) to its customers 204 via the CMA 206. In this example, the online concierge system 102 may communicate information to the shopping cart system 150 identifying certain content items 605 that are trending among customers 204 of the online concierge system 102. In the above example, the trending content items 605 may be included among those identified 420 by the shopping cart system 150 for inclusion in the user interface to be sent for display to the customer 204 (e.g., if contextual information associated with the shopping cart 156 indicates the shopping cart 156 is within a threshold distance of one or more items 505 associated with the trending content items 605).

In some embodiments, the shopping cart system 150 may not identify 420 a content item 605 to include in the user interface to be sent for display to the customer 204 based on a type associated with the content item 605 and contextual information associated with the shopping cart 156. In various embodiments, the shopping cart system 150 may not identify 420 a content item 605 if the content item 605 is unlikely to encourage the customer 204 to perform an action associated with an item 505 (e.g., to purchase the item 505). For example, suppose that a content item 605 corresponds to an advertisement for spaghetti sauce and contextual information associated with the shopping cart 156 indicates that spaghetti sauce is included among the items 505 within the shopping cart 156. In this example, the content item 605 may not be included among the set of content items 605 identified 420 by the shopping cart system 150 to include in the user interface to be sent for display to the customer 204 since the customer 204 is already likely to purchase the spaghetti sauce if it is in their shopping cart 156. However, in the above example, if the content item 605 is a coupon for the spaghetti sauce, the content item 605 may be included among the set of content items 605 identified 420 by the shopping cart system 150 since the customer 204 is more likely to purchase more of the spaghetti sauce with the coupon.

The shopping cart system 150 then generates 425 (e.g., using the user interface engine 332) the user interface including the set of identified content items 605. For example, if the shopping cart system 150 identifies 420 multiple content items 605, the shopping cart system 150 may generate 425 the user interface with the content items 605 organized in a grid format or in a horizontally or vertically scrollable carousel format. In embodiments in which the shopping cart system 150 identifies 420 multiple content items 605 to include in the user interface to be sent for display to the customer 204, the content items 605 may be arranged based on a likelihood that the customer 204 subsequently will perform an action associated with each content item 605. For example, if the user interface includes multiple content items 605, a content item 605 associated with an action that the customer 204 is most likely to perform is arranged in a most prominent position of the user interface and a content item 605 associated with an action that the customer 204 is least likely to perform is arranged in a least prominent position. In such embodiments, the shopping cart system 150 may determine the likelihood associated with each content item 605 based on information included in the user profile of the customer 204. For example, the shopping cart system 150 may determine a likelihood that the customer 204 will perform an action associated with a content item 605 based on information included in the user profile of the customer 204 maintained in the shopping cart system 150 (e.g., in the attribution database 338). In this example, the information included in the user profile may describe whether events associated with similar actions performed by the customer 204 were attributed to including similar content items 605 in a user interface previously sent to a display area associated with the customer 204. In some embodiments, a server that communicates with the shopping cart system 150 may generate 425 the user interface. For example, a server associated with the online concierge system 102 may generate 425 the user interface and communicate the user interface to the shopping cart system 150.

Once the user interface is generated 425, the shopping cart system 150 sends 430 (e.g., using the user interface engine 332) the user interface to a display area associated with the customer 204. In some embodiments, the shopping cart system 150 sends 430 the user interface to a display area included in a client device 110 associated with the customer 204. For example, the shopping cart system 150 may send 430 the user interface to a display area included in a client device 110 associated with the customer 204 (e.g., in a push notification via the CMA 206). In various embodiments, the shopping cart system 150 also or alternatively sends 430 the user interface to a display area 159 included in the shopping cart system 150.

In some embodiments, the shopping cart system 150 subsequently may detect 435 (e.g., using the event detection engine 322) an event associated with one or more items 505 associated with the set of content items 605 included in the user interface sent 430 to the display area associated with the customer 204. Examples of events that may be detected 435 by the shopping cart system 150 include stopping the shopping cart 156 within a threshold distance of an item 505 within the physical retail store 104 for at least a threshold amount of time, moving the shopping cart 156 within a threshold distance of an item 505 within the physical retail store 104, picking up an item 505 from a specific location within the physical retail store 104 (e.g., a promotional display area), adding an item 505 to the shopping cart 156, purchasing an item 505 from the physical retail store 104, or any other types of events that may be associated with the customer 204 within the physical retail store 104. In embodiments in which the event detected 435 by the shopping cart system 150 corresponds to stopping the shopping cart 156 within a threshold distance of an item 505 within the physical retail store 104 for at least a threshold amount of time, the threshold amount of time and/or distance may be determined by a machine-learned model (e.g., a model trained based on anonymous aggregated data describing customer behavior associated with shopping carts 156 when deciding whether to purchase items 505).

The shopping cart system 150 may detect 435 the event associated with one or more items 505 associated with the set of content items 605 included in the user interface sent 430 to the display area associated with the customer 204 based on contextual information associated with the shopping cart 156 tracked 410 by the shopping cart system 150 and/or the planogram 500 associated with the physical retail store 104. For example, suppose that a particular item 505 associated with a content item 605 included in the user interface sent 430 to the display area associated with the customer 204 is placed in two different locations within the physical retail store 104, in which one location is its normal location within an aisle and the other location is a promotional display area at the end of a different aisle. In this example, the shopping cart system 150 may detect 435 an event corresponding to adding the item 505 to the shopping cart 156, in which the shopping cart system 150 also detects 435 the location at which the item 505 was added to the shopping cart 156 (e.g., based on the planogram 500 associated with the physical retail store 104). In the above example, the shopping cart system 150 also subsequently may detect 435 an event corresponding to purchasing the item 505 based on contextual information associated with the shopping cart 156 and the planogram 500 associated with the physical retail store 104, which indicate that the shopping cart 156 exited a checkout line within the physical retail store 104 with the item 505.

Although not illustrated in FIG. 4, in some embodiments, the shopping cart system 150 may store information describing the event (e.g., in the event database 324). In various embodiments, this information also or alternatively may be communicated to and stored in the online concierge system 102 (e.g., in the transaction records database 308 and/or the training datasets 320). The shopping cart system 150 may store information describing the event in association with information identifying the customer 204 associated with the event (e.g., based on login credentials provided by the customer 204), information identifying the physical retail store 104 at which the event was detected 435, a time at which the event was detected 435, a location within the physical retail store 104 at which the event was detected 435, or any other information associated with the event. For example, suppose that the shopping cart system 150 detects 435 that the customer 204 added an item 505 to the shopping cart 156. In this example, information describing the event, such as the type of event (i.e., adding an item 505 to the shopping cart 156) and information describing the item 505 (e.g., the type of item 505, a size of the item 505, a brand of the item 505, etc.) may be stored (e.g., in the event database 324, the transaction records database 308, and/or the training datasets 320). In the above example, the information describing the event may be stored in association with information identifying the physical retail store 104 (e.g., its name and address), a time at which the item 505 was added to the shopping cart 156, an aisle within the physical retail store 104 in which the customer 204 added the item 505 to the shopping cart 156, and a username associated with the customer 204 in the online concierge system 102.

The shopping cart system 150 may then determine 440 (e.g., using the attribution engine 336) whether to attribute the event detected 435 by the shopping cart system 150 to including a content item 605 in the user interface sent 430 for display to the customer 204. The shopping cart system 150 may make the determination based on a first time at which the user interface was sent 430 to the display area associated with the customer 204 and a second time at which the event was detected 435 by the shopping cart system 150. In some embodiments, once the user interface is sent 430 to the display area associated with the customer 204 during the shopping session, the shopping cart system 150 may determine 440 that any subsequent events detected 435 by the shopping cart system 150 during the shopping session may be attributed to including a content item 605 associated with the event in the user interface. For example, suppose that the shopping cart system 150 sends 430 the user interface to the display area associated with the customer 204, in which the user interface includes a content item 605 corresponding to a coupon for an item 505. In this example, the shopping cart system 150 may determine 440 that the addition of the item 505 to the shopping cart 156 by the customer 204 and the purchase of the item 505 by the customer 204 subsequently detected 435 by the shopping cart system 150 should be attributed to including the content item 605 in the user interface sent 430 for display to the customer 204.

Although not illustrated in FIG. 4, in some embodiments, once the shopping cart system 150 determines 440 whether to attribute the event detected 435 by the shopping cart system 150 to including a content item 605 in the user interface sent 430 for display to the customer 204, the shopping cart system 150 may store information describing the determination (e.g., in the attribution database 338). The stored information may include information describing the content item 605, information describing a time at which the user interface was sent 430 to the display area associated with the customer 204, information describing the display area (e.g., whether the display area is included in a client device 110 or the shopping cart system 150), information identifying the customer 204, information describing the event that was or was not attributed to including the content item 605 in the user interface (e.g., a time at which the event was detected 435, information identifying an item 505 associated with the event, etc.), or any other suitable information describing the determination made by the shopping cart system 150. In embodiments in which information describing the determination identifies the customer 204, the information may be included among user profile information associated with the customer 204.

In some embodiments, the shopping cart system 150 also computes 445 (e.g., using the performance engine 340) a performance metric associated with a content item 605 included in the user interface sent 430 for display to the customer 204. The shopping cart system 150 may compute 445 the performance metric based in part on the determination by the shopping cart system 150 whether to attribute the event detected 435 by the shopping cart system 150 to including the content item 605 in the user interface sent 430 to the display area associated with the customer 204. The performance metric may correspond to a conversion rate, a click-through rate (CTR), or any other suitable metric that describes a performance of a content item 605. For example, a performance metric associated with a content item 605 may correspond to a conversion rate, in which the conversion rate describes a rate at which customers 204 of a physical retail store 104 presented with the content item 605 during their shopping sessions subsequently added an item 505 associated with the content item 605 to their shopping carts 156. As an additional example, a performance metric associated with a content item 605 may correspond to a click-through rate, in which the click-through rate describes a rate at which customers 204 presented with the content item 605 clicked on the content item 605 to view a recipe associated with an item 505. Although not illustrated in FIG. 4, in some embodiments, the shopping cart system 150 may be configured to store information describing the performance metric (e.g., in the performance database 342). Furthermore, in some embodiments, the determination by the shopping cart system 150 whether to attribute the event to including a content item 605 in the user interface sent 430 to the display area associated with the customer 204 may be communicated to the online concierge system 102 and used by the online concierge system 102 to compute 445 a performance metric associated with the content item 605. In such embodiments, the online concierge system 102 may access the shopping cart system 150 to retrieve the determination or the shopping cart system 150 may communicate the determination to the online concierge system 102.

The shopping cart system 150 may then communicate 450 the performance metric associated with the content item 605 to an entity associated with the physical retail store 104, a third-party system 130, and/or the online concierge system 102. For example, suppose that the performance metric associated with the content item 605 corresponds to a conversion rate associated with the content item 605 and the content item 605 corresponds to a coupon offered by the physical retail store 104 for an item 505. In this example, the performance metric may indicate a rate at which customers 204 presented with the content item 605 subsequently added the item 505 to their shopping carts 156 and may be communicated 450 to an entity associated with the physical retail store 104 as an indication of effectiveness of the coupon at encouraging customers 204 to add the item 505 to their shopping carts 156. As an additional example, if a performance metric associated with a content item 605 corresponds to a click-through rate and the content item 605 corresponds to an advertisement, the performance metric may be communicated 450 to a third-party system 130 associated with the advertisement as an indication of effectiveness of the advertisement. As yet another example, suppose that a performance metric associated with a content item 605 corresponds to a conversion rate and the content item 605 corresponds to product information associated with an item 505. In this example, the performance metric may be communicated 450 to the online concierge system 102, which may increase or decrease the prominence of the product information displayed to its customers 204 in the online concierge system 102 based on the performance metric.

In various embodiments, information associated with one or more items 505 associated with a content item 605 included in the user interface sent 430 for display to the customer 204 may be updated 455 based on the performance metric associated with the content item 605. In some embodiments, the updated information may be maintained in the shopping cart system 150, while in other embodiments, the updated information may be maintained in the online concierge system 102. For example, if a performance metric associated with a content item 605 computed 445 by the shopping cart system 150 corresponds to a low conversion rate for an item 505 associated with the content item 605 and the content item 605 corresponds to a recipe in which the item 505 is included as an ingredient, the content item 605 may be updated 455 in the shopping cart system 150 with a different recipe. As an additional example, suppose that a performance metric associated with a content item 605 computed 445 by the shopping cart system 150 corresponds to a high conversion rate for an item 505 associated with the content item 605 and the content item 605 corresponds to nutritional information associated with the item 505. In this example, if the performance metric is communicated 450 to the online concierge system 102, the online concierge system 102 may update 455 the product information for the item 505 to highlight the nutritional information.

Although not shown in FIG. 4, in some embodiments, after detecting (e.g., using the event detection engine 322) the conclusion of the shopping session, the same shopping cart system 150 subsequently may detect 405 (e.g., via the event detection engine 322) the initiation of an additional shopping session within the physical retail store 104 by an additional customer 204 of the physical retail store 104. Some or all of the additional steps (e.g., steps 410-455) described above may then be performed with respect to the additional customer 204.

### Additional Considerations

The foregoing description of the embodiments of the invention has been presented for the purpose of illustration; it is not intended to be exhaustive or to limit the invention to the precise forms disclosed. Many modifications and variations are possible in light of the above disclosure.

Some portions of this description describe the embodiments of the invention in terms of algorithms and symbolic representations of operations on information. These algorithmic descriptions and representations are commonly used in the data processing arts to convey the substance of their work effectively to others. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a computing device selectively activated or reconfigured by a computer program stored in the computer. Such a computer program may be stored in a tangible computer readable storage medium, which include any type of tangible media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A method comprising:
receiving, by an online system comprising one or more processors, from a shopping cart system, an initiation of a shopping session within a physical retail store by a customer of the physical retail store, wherein the shopping cart system comprises a shopping cart, a processor, a memory, and a set of sensors;
receiving, by the online system, contextual information associated with the shopping cart generated by the set of sensors during the shopping session, the contextual information describing one or more locations of the shopping cart within the physical retail store, a state of the shopping cart, and a set of items within the shopping cart;
tracking, by the one or more processors of the online system, the contextual information associated with the shopping cart;
identifying, by the one or more processors of the online system, an opportunity to present content to the customer based at least in part on the tracking of the contextual information associated with the shopping cart;
responsive to identifying the opportunity to present the content to the customer, identifying, by the one or more processors of the online system, a set of content items associated with one or more items within the physical retail store based at least in part on the contextual information associated with the shopping cart;
generating, by the one or more processors of the online system, a-user interface content comprising the set of content items; and
sending, from the online system, the user interface content to a display area of a client device associated with the customer, wherein sending the user interface content to the display area of the client device associated with the customer causes the user interface content comprising the set of content items to be displayed in the display area of the client device to the customer.

2. The method of claim 1, wherein identifying the opportunity to present the content to the customer comprises one or more of: detecting that the shopping cart has been stationary for at least a threshold amount of time and detecting a specific item of the set of items within the shopping cart.

3. The method of claim 2, wherein identifying the set of content items associated with the one or more items within the physical retail store based at least in part on the contextual information associated with the shopping cart comprises:
comparing a location of the one or more locations of the shopping cart within the physical retail store while the shopping cart has been stationary for at least the threshold amount of time to a planogram associated with the physical retail store, wherein the planogram indicates a placement of each of a plurality of items within the physical retail store;
identifying the one or more items within the physical retail store based at least in part on the comparing, wherein the one or more items are within a threshold distance of the location of the one or more locations of the shopping cart; and
identifying the set of content items based at least in part on the identified one or more items.

4. The method of claim 1, wherein the set of content items comprises one or more of: product information associated with an item of the one or more items, a promotion for the item of the one or more items, a coupon for the item of the one or more items, a set of instructions for using the item of the one or more items, a suggested use for the item of the one or more items, and an advertisement for the item of the one or more items.

5. The method of claim 1, further comprising:
detecting an event associated with the one or more items based at least in part on one or more of: the contextual information associated with the shopping cart and a planogram associated with the physical retail store, wherein the planogram indicates a placement of each of a plurality of items within the physical retail store;
determining whether to attribute the event to the set of content items being included in the user interface sent to the display area associated with the customer, the determining based at least in part on a first time at which the user interface was sent to the display area associated with the customer and a second time at which the event was detected;
computing a performance metric associated with a content item of the set of content items based at least in part on the determining whether to attribute the event to the set of content items being included in the user interface sent to the display area associated with the customer; and
communicating the performance metric associated with the content item to one or more of: an entity associated with the physical retail store, a third-party system associated with the content item, and an online concierge system associated with the physical retail store.

6. The method of claim 5, wherein the event is selected from the group consisting of: adding the one or more items to the shopping cart and purchasing the one or more items.

7. The method of claim 5, further comprising:
updating information maintained in the online concierge system based at least in part on the performance metric, wherein the updated information is associated with the one or more items.

8. A computer program product comprising a non-transitory computer readable storage medium having instructions encoded thereon that, when executed by a processor, cause the processor to:
receive, by an online system comprising one or more processors, from a shopping cart system, an initiation of a shopping session within a physical retail store by a customer of the physical retail store, wherein the shopping cart system comprises a shopping cart, a processor, a memory, and a set of sensors;
receive, by the online system, contextual information associated with the shopping cart generated by the set of sensors during the shopping session, the contextual information describing one or more locations of the shopping cart within the physical retail store, a state of the shopping cart, and a set of items within the shopping cart;
track, by the one or more processors of the online system, the contextual information associated with the shopping cart;
identify, by the one or more processors of the online system, an opportunity to present content to the customer based at least in part on the tracking of the contextual information associated with the shopping cart;
responsive to identifying the opportunity to present the content to the customer, identify, by the one or more processors of the online system, a set of content items associated with one or more items within the physical retail store based at least in part on the contextual information associated with the shopping cart;
generate, by the one or more processors of the online system, user interface content comprising the set of content items; and
send, from the online system, the user interface content to a display area of a client device associated with the customer, causing the user interface content to be displayed in the display area of the client device to the customer.

9. The computer program product of claim 8, wherein identify the opportunity to present the content to the customer comprises one or more of: detecting that the shopping cart has been stationary for at least a threshold amount of time and detecting a specific item of the set of items within the shopping cart.

10. The computer program product of claim 9, wherein identify the set of content items associated with the one or more items within the physical retail store based at least in part on the contextual information associated with the shopping cart comprises:
compare a location of the one or more locations of the shopping cart within the physical retail store while the shopping cart has been stationary for at least the threshold amount of time to a planogram associated with the physical retail store, wherein the planogram indicates a placement of each of a plurality of items within the physical retail store;
identify the one or more items within the physical retail store based at least in part on the comparing, wherein the one or more items are within a threshold distance of the location of the one or more locations of the shopping cart; and
identify the set of content items based at least in part on the identified one or more items.

11. The computer program product of claim 8, wherein the set of content items comprises one or more of: product information associated with an item of the one or more items, a promotion for the item of the one or more items, a coupon for the item of the one or more items, a set of instructions for using the item of the one or more items, a suggested use for the item of the one or more items, and an advertisement for the item of the one or more items.

12. The computer program product of claim 8, wherein the computer readable storage medium further has instructions encoded thereon that, when executed by the processor, cause the processor to:
detect an event associated with the one or more items based at least in part on one or more of: the contextual information associated with the shopping cart and a planogram associated with the physical retail store, wherein the planogram indicates a placement of each of a plurality of items within the physical retail store;
determine whether to attribute the event to the set of content items being included in the user interface sent to the display area associated with the customer, the determining based at least in part on a first time at which the user interface was sent to the display area associated with the customer and a second time at which the event was detected;
compute a performance metric associated with a content item of the set of content items based at least in part on the determining whether to attribute the event to the set of content items being included in the user interface sent to the display area associated with the customer; and
communicate the performance metric associated with the content item to one or more of: an entity associated with the physical retail store, a third-party system associated with the content item, and an online concierge system associated with the physical retail store.

13. The computer program product of claim 12, wherein the event is selected from the group consisting of: adding the one or more items to the shopping cart and purchasing the one or more items.

14. The computer program product of claim 12, wherein the computer readable storage medium further has instructions encoded thereon that, when executed by the processor, cause the processor to:
update information maintained in the online concierge system based at least in part on the performance metric, wherein the updated information is associated with the one or more items.

15. A shopping cart system comprising:
a processor;
a non-transitory computer readable storage medium storing instructions that, when executed by the processor, cause the shopping cart system to perform actions comprising:
receiving, by an online system comprising one or more processors, from the shopping cart system, an initiation of a shopping session within a physical retail store by a customer of the physical retail store, wherein the shopping cart system comprises a shopping cart, a processor, a memory, and a set of sensors;
receiving, by the online system, contextual information associated with the shopping cart generated by the set of sensors during the shopping session, the contextual information describing one or more locations of the shopping cart within the physical retail store, a state of the shopping cart, and a set of items within the shopping cart;
tracking, by the one or more processors of the online system, the contextual information associated with the shopping cart;
identifying, by the one or more processors of the online system, an opportunity to present content to the customer based at least in part on the contextual information associated with the tracking of the shopping cart;
responsive to identifying the opportunity to present the content to the customer, identifying, by the one or more processors of the online system, a set of content items associated with one or more items within the physical retail store based at least in part on the contextual information associated with the shopping cart;
generating, by the one or more processors of the online system, user interface content comprising the set of content items; and
sending, from the online system, the user interface content to a display area of a client device associated with the customer, causing the user interface content to be displayed in the display area of the client device to the customer.

16. The shopping cart system of claim 15, wherein identifying the opportunity to present the content to the customer comprises one or more of: detecting that the shopping cart has been stationary for at least a threshold amount of time and detecting a specific item of the set of items within the shopping cart.

17. The shopping cart system of claim 16, wherein identifying the set of content items associated with the one or more items within the physical retail store based at least in part on the contextual information associated with the shopping cart comprises:
comparing a location of the one or more locations of the shopping cart within the physical retail store while the shopping cart has been stationary for at least the threshold amount of time to a planogram associated with the physical retail store, wherein the planogram indicates a placement of each of a plurality of items within the physical retail store;
identifying the one or more items within the physical retail store based at least in part on the comparing, wherein the one or more items are within a threshold distance of the location of the one or more locations of the shopping cart; and
identifying the set of content items based at least in part on the identified one or more items.

18. The shopping cart system of claim 15, wherein the set of content items comprises one or more of: product information associated with an item of the one or more items, a promotion for the item of the one or more items, a coupon for the item of the one or more items, a set of instructions for using the item of the one or more items, a suggested use for the item of the one or more items, and an advertisement for the item of the one or more items.

19. The shopping cart system of claim 15, wherein the computer readable storage medium further has instructions encoded thereon that, when executed by the processor, cause the shopping cart system to perform actions comprising:
detecting an event associated with the one or more items based at least in part on one or more of: the contextual information associated with the shopping cart and a planogram associated with the physical retail store, wherein the planogram indicates a placement of each of a plurality of items within the physical retail store;
determining whether to attribute the event to the set of content items being included in the user interface sent to the display area associated with the customer, the determining based at least in part on a first time at which the user interface was sent to the display area associated with the customer and a second time at which the event was detected;
computing a performance metric associated with a content item of the set of content items based at least in part on the determining whether to attribute the event to the set of content items being included in the user interface sent to the display area associated with the customer; and
communicating the performance metric associated with the content item to one or more of: an entity associated with the physical retail store, a third-party system associated with the content item, and an online concierge system associated with the physical retail store.

20. The shopping cart system of claim 19, wherein the event is selected from the group consisting of: adding the one or more items to the shopping cart and purchasing the one or more items.
